(19) United States
(12) Patent Application Publication
(10) Pub. No.: US 2012/0281657 A1
(43) Pub. Date: Nov. 8, 2012

(54) METHOD FOR DOWNLINK MULTI-ANTENNA MULTI-BASE STATION INTERFERENCE COORDINATION AND BASE STATION

(76) Inventors: Ming Ding, Pudong (CN); Renmao Liu, Pudong (CN); Yongming Liang, Pudong (CN); Yingyu Zhang, Pudong (CN); Zeng Yang, Pudong (CN)

(21) Appl. No.: 13/520,994

(22) PCT Filed: Jan. 7, 2011
(86) PCT No.: PCT/JP2011/050603

§ 371 Date: Jul. 6, 2012

(30) Foreign Application Priority Data
Jan. 7, 2010 (CN) 201010002031.2

(51) Int. Cl. H04B 15/00; H04W 72/04

(52) U.S. Cl. 370/329

(57) ABSTRACT

A base station in a downlink multi-antenna multi-base station system comprises: a unit for acquiring spatial domain characteristic information for downlink interference; a unit for generating an interference coordination indication based on the spatial domain characteristic information for downlink interference; and a background interface communication unit for transmitting the generated interference coordination indication to a neighboring base station, instructing the neighboring base station to perform resource scheduling, thereby reducing or eliminating interference on the base station. Also disclosed is a method for interference coordination, which is capable of reducing or eliminating interference on a serving base station from its neighboring base stations by utilizing an interference coordination indication transmitted from the serving base station. Only a small amount of inter-base station signaling interaction is required to achieve distributed inter-cell interference coordination. The present invention has the advantages of low signaling overhead, simple implementation, decreased delay, and flexible adaptation.

### TECHNICAL FIELD

The invention relates to communication technology, and more particularly, to a method for downlink multi-antenna multi-base station interference coordination and a corresponding base station, capable of reducing or eliminating interference on a serving base station from a neighboring base station by utilizing an interference coordination indication transmitted from the serving base station to the neighboring base station.

### BACKGROUND ART

Multi-antenna wireless transmission technology, or Multiple In Multiple Out (MIMO), can achieve spatial multiplex gain and spatial diversity gain by deploying a plurality of antennas at both the transmitter and the receiver and utilizing the spatial resources in wireless transmission. Researches on information theory show that the capacity of a MIMO system grows linearly with the minimum of the number of transmitting antennas and the number of receiving antennas.

FIG. 1 shows a schematic diagram of an MIMO system. As shown in FIG. 1, a plurality of antennas at the transmitter and a plurality of antennas at each of the receivers constitute a multi-antenna wireless channel containing spatial domain information. Further, Orthogonal Frequency Division Multiplexing (OFDM) technology has a strong anti-fading capability and high frequency utilization and is thus suitable for high speed data transmission in a multi-path and fading environment. The MIMO-OFDM technology, in which MIMO and OFDM are combined, has become a core technology for a new generation of mobile communication.

For instance, the 3rd Generation Partnership Project (3GPP) organization is an international organization in mobile communication field which plays an important role in standardization of 3G cellular communication technologies. Since the second half of the year 2004, the 3GPP organization has initiated a so-called Long Term Evolution (LTE) project for designing Evolved Universal Terrestrial Radio Access (EUTRA) and Evolved Universal Terrestrial Radio Access Network (EUTRAN). The MIMO-OFDM technology is employed in the downlink of the LTE system. In a conference held in Shenzhen, China in April 2008, the 3GPP organization started a discussion on the standardization of 4G cellular communication systems (currently referred to as LTE-A systems). In the conference, a concept of “multi-antenna multi-base station coordination” attracts extensive attention and support. The core idea of the concept is to solve the problem of downlink inter-cell interference by coordination among multiple base stations, such that the data transmission rate of a user at the edge of the cell can be increased.

In a downlink multi-antenna multi-base station system, there are mainly two categories of coordination approaches, multi-base station joint processing and multi-base station interference coordination. The multi-base station joint processing mainly comprises the following schemes:

a) Virtual MIMO. Multiple antennas at multiple base stations are considered as a single base station MIMO system with more antennas, so as to achieve higher spatial multiplex and spatial diversity gains. Additionally, the mechanism of reusing the single station MIMO system is useful for reducing the implementation complexity of the multi-antenna multi-base station system.

b) Independent operation of single base station. Each single base station equipped with multi-antenna independently serves a user equipment which then adds the data from a number of single base stations to achieve higher spatial multiplex and spatial diversity gains. This scheme is easy to implement and has low signaling overhead.

c) Simple combination of channels from multiple base stations. From the perspective of a user equipment, the channels from the coordinating base stations to the user equipment can be added and combined directly to form a virtual channel to which single base station MIMO technologies can be applied.

On the other hand, the multi-base station interference coordination mainly comprises the following three coordination schemes:

1) Transmission power control based on spectral resource block. A base station transmits to its neighboring base station a transmission power indication in units of spectral resource blocks. For each spectral resource block as a report unit, the indication indicates whether the transmission power exceeds a predetermined threshold or not. Upon reception of the transmission power indication, a base station can take measures, such as resource scheduling, to prevent users susceptible to interference from being allocated to spectral resource blocks with strong interferences. This is described in 3GPP TS 36.423 “X2 application protocol”. The scheme for transmission power control based on spectral resource block has the advantages of simplicity, flexibility and low signaling overhead.

2) Spatial domain beam coordination. A user equipment feeds back to a base station spatial domain characteristic information associated with the interference from a neighboring base station, indicating for example which spatial domain beams used by the neighboring base station will cause large interference, which spatial domain beams will have small interference or the like. The base station can notify the spatial domain characteristic information associated with the interference to the neighboring base station which can then take measures, such as resource scheduling, for interference coordination. This is described in 3GPP R1-094613, “Best Companion Reporting for Single-Cell MU-MIMO Pairing”, Alcatel-Lucent, Alcatel-Lucent Shanghai Bell. The scheme based on spatial domain beam coordination has the advantages of low feedback overhead and simple implementation, but fails to incorporate the inter-base station background signaling.

3) Design of inter-base station background signaling based on the concept of 2). A base station uses 4 bits to notify, in units of spectral resource blocks, its neighboring base station which spatial domain beam, if used by the neighboring base station, will cause large interference, or which spatial domain beam will have the minimum interference. This is described in 3GPP R1-094555, “Considerations on Spatial Domain Coordination in LTE-A”, CATT. This scheme has, again, the advantage of low signaling overhead, but is only suitable for the scenario in which the base station is configured to notify its neighboring base station which spatial domain beam, if used by the neighboring base station, will cause large interference, or which spatial domain beam will have the minimum interference. Furthermore, this scheme can only notify one beam at a time, which leads to insufficient interference coordination information in multi-user MIMO communication or redundant interference coordination information when the overall interference of the network is moderate.

### SUMMARY OF INVENTION

It is an object of the present invention to solve the problem of some improper designs of downlink multi-base station interference coordination indication in the prior art by providing a novel method for multi-antenna multi-base station interference coordination and a corresponding base station.

According to the first solution of the present invention, there is provided a base station comprising: a spatial domain information acquisition unit for acquiring spatial domain characteristic information for downlink interference; an interference coordination indication generation unit for generating an interference coordination indication based on the spatial domain characteristic information for downlink interference acquired by the spatial domain information acquisition unit; and a background interface communication unit for transmitting, by means of background interface communication, the generated interference coordination indication to a neighboring base station, instructing the neighboring base station to perform resource scheduling, thereby reducing or eliminating interference on the base station.

In addition, the base station may further comprise a resource scheduling unit for performing resource scheduling based on an interference coordination indication received from a neighboring base station via the background interface communication unit, so as to reduce or eliminate interference on the neighboring base station.

According to the second solution of the present invention, there is provided a method for interference coordination comprising: acquiring, by a serving base station, spatial domain characteristic information for downlink interference; generating, by the serving base station, an interference coordination indication based on the acquired spatial domain characteristic information for downlink interference; transmitting, by the serving base station, the generated interference coordination indication to a neighboring base station by means of background interface communication; and performing, by the neighboring base station, resource scheduling based on the received interference coordination indication, so as to reduce or eliminate interference on the serving base station.

Preferably, the interference coordination indication is used to indicate at least one of:

[1] information on a spatial domain beam to be used by the serving base station;

[2] information on a spatial domain beam which is not used or will no longer be used by the serving base station;

[3] information on a spatial domain beam which the serving base station does not desire a neighboring base station to use; and

[4] information on a spatial domain beam which the serving base station desires a neighboring base station to use.

Preferably, a number of spatial domain beams are grouped into a spatial domain beam sub-space; and the interference coordination indication is used to indicate at least one of:

[1] information on a spatial domain beam sub-space to be used by the serving base station;

[2] information on a spatial domain beam sub-space which is not used or will no longer be used by the serving base station;

[3] information on a spatial domain beam sub-space which the serving base station does not desire a neighboring base station to use; and

[4] information on a spatial domain beam sub-space which the serving base station desires a neighboring base station to use.

Preferably, the serving base station transmits an interference coordination indication to its neighboring base stations in an omni-directional manner when the interference coordination indication indicates one of: information on a spatial domain beam to be used by the serving base station; information on a spatial domain beam which is not used or will no longer be used by the serving base station; information on a spatial domain beam sub-space to be used by the serving base station; and information on a spatial domain beam sub-space which is not used or will no longer be used by the serving base station.

Preferably, the serving base station transmits an interference coordination indication to a neighboring base station associated with the interference coordination indication in a directional manner when the interference coordination indication indicates one of: information on a spatial domain beam which the serving base station does not desire the neighboring base station to use; information on a spatial domain beam which the serving base station desires the neighboring base station to use; information on a spatial domain beam sub-space which the serving base station does not desire the neighboring base station to use; and information on a spatial domain beam sub-space which the serving base station desires the neighboring base station to use.

Preferably, the interference coordination indication is a two-level indication using a bit string type of signaling. Alternatively, the interference coordination indication is a multi-level indication using an enumerative type of signaling. Alternatively, the interference coordination indication is a two-dimensional table with a first dimension representing spectral resource blocks and a second dimension representing spatial domain beams or spatial domain beam sub-spaces. Alternatively, the interference coordination indication is a one-dimensional list, each element of which contains an index number for a spectral resource block concatenated with an index number for a spatial domain beam, or an index number for a spectral resource block concatenated with an index number for a spatial domain beam sub-space.

Preferably, the interference coordination indication contains additional information indicating multi-user MIMO communication load. More preferably, the additional information indicating multi-user MIMO communication load can be a spectral resource block based two-level indication using a bit string type of signaling. Alternatively, the additional information indicating multi-user MIMO communication load can be a spectral resource block based multi-level indication using an enumerative type of signaling. More preferably, the serving base station can transmit the interference coordination indication to its neighboring base stations in an omni-directional manner.

In a multi-antenna multi-base station system adopting the interference coordination method according to the present invention, only a small amount of inter-base station signaling interaction is required to achieve distributed inter-cell interference coordination. Thus, the present invention has the advantages of low signaling overhead, simple implementation, decreased delay, flexible adaptation and the like.

### BRIEF DESCRIPTION OF DRAWINGS

The above and other objects, features and advantages of the present invention will be more apparent from the following preferred embodiments illustrated with reference to the figures, in which:

FIG. 1 is a schematic diagram of a MIMO system;

FIG. 2 is a schematic diagram of a multi-cell cellular communication system;

FIG. 3 is a flowchart illustrating the method for interference coordination according to the present invention;

FIG. 4 is a schematic diagram of a first specific form for the interference coordination indication;

FIG. 5 is a schematic diagram of a second specific form for the interference coordination indication;

FIG. 6 is a schematic diagram illustrating the 1^{st}, 5^{th}, 9^{th} and 13^{th} embodiments of the interference coordination indication generated by a base station;

FIG. 7 is a schematic diagram illustrating the 2^{nd}, 6^{th}, 10^{th} and 14^{th} embodiments of the interference coordination indication generated by a base station;

FIG. 8 is a schematic diagram illustrating the 3^{rd}, 7^{th}, 11^{th} and 15^{th} embodiments of the interference coordination indication generated by the base station;

FIG. 9 is a schematic diagram illustrating the 4^{th}, 8^{th}, 12^{th} and 16^{th} embodiments of the interference coordination indication generated by the base station;

FIG. 10 is a schematic diagram illustrating the 33^{rd} embodiment of the interference coordination indication generated by the base station;

FIG. 11 is a schematic diagram illustrating the 34^{th} embodiment of the interference coordination indication generated by the base station; and

FIG. 12 is an illustrative block diagram of a base station according to the present invention.

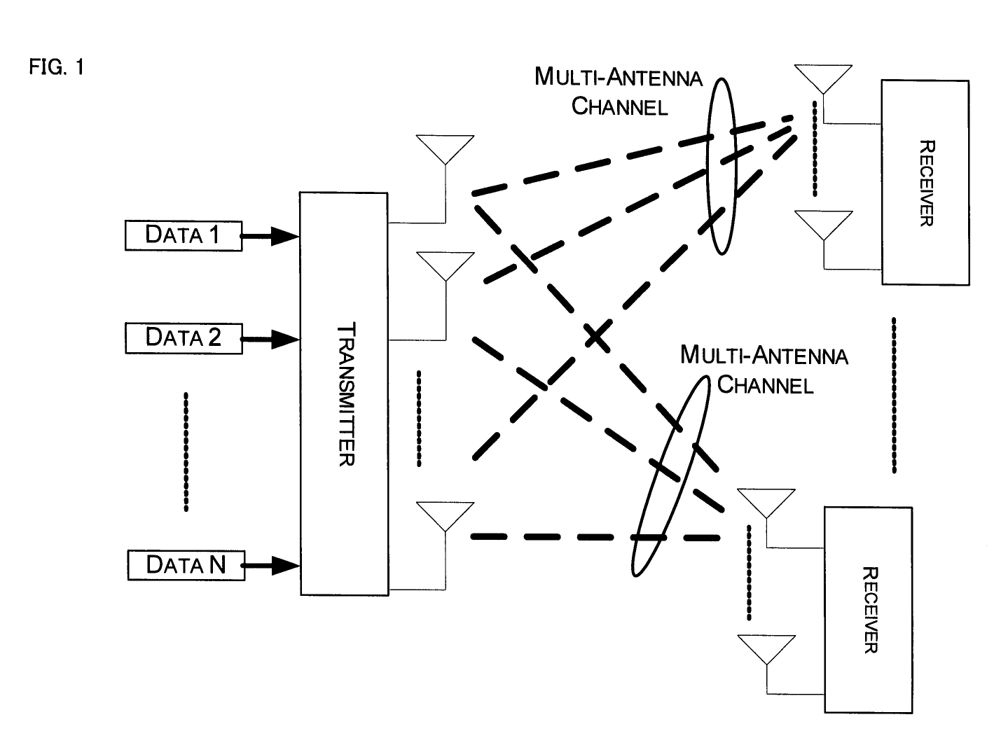

### DESCRIPTION OF EMBODIMENTS

Preferred embodiments of the present invention will be detailed with reference to the drawings. In the following description, details and functions unnecessary to the present invention are omitted so as not to obscure the concept of the invention.

For clear and detailed explanation of the implementation steps of the present invention, some specific examples applicable to downlink LTE cellular communication system are given below. Herein, it is to be noted that the present invention is not limited to the application exemplified in the embodiments.

Rather, it is applicable to other communication systems, such as the future LTE-A system.

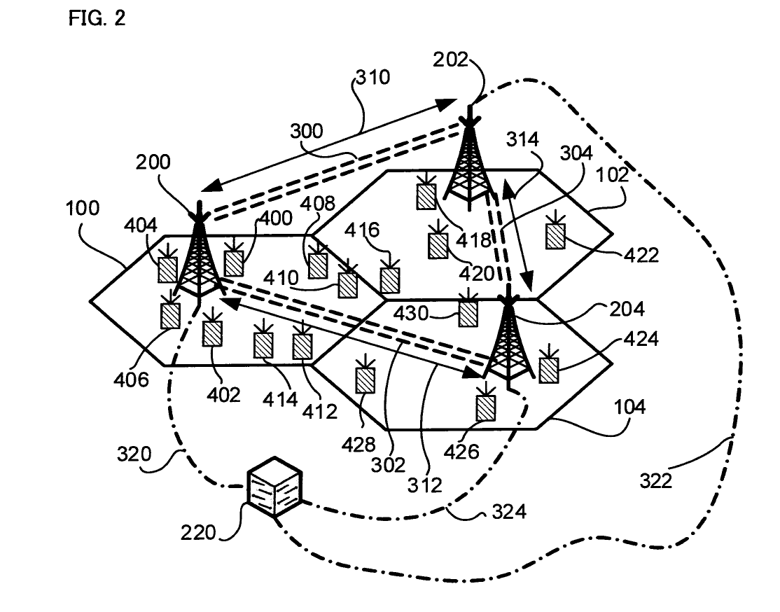

FIG. 2 is a schematic diagram of a multi-cell cellular communication system. The cellular system divides a service coverage area into a number of adjacent wireless coverage areas, i.e., cells. In FIG. 2, the entire service area is formed by cells 100, 102 and 104, each being illustratively shown as a hexagon. Base Stations (BSs) 200, 202 and 204 are associated with the cells 100, 102 and 104, respectively. As known to those skilled in the art, each of the BSs 200-204 comprises at least a transmitter and a receiver. Herein, it is to be noted that a BS, which is generally a serving node in a cell, can be an independent BS having a function of resource scheduling, a transmitting node belonging to an independent BS, a relay node (which is generally configured for further enlarging the coverage of a cell), or the like. As illustratively shown in FIG. 2, each of the BSs 200-204 is located in a particular area of the corresponding one of the cells 100-104 and is equipped with an omni-directional antenna. However, in a cell arrangement for the cellular communication system, each of the BSs 200-204 can also be equipped with a directional antenna for directionally covering a partial area of the corresponding one of the cells 100-104, which is commonly referred to as a sector. Thus, the diagram of the multi-cell cellular communication system as shown in FIG. 2 is illustrative only and does not imply that the implementation of the cellular system according to the present invention is limited to the above particular constraints.

As shown in FIG. 2, the BSs 200-204 are connected with each other via X2 interfaces 300, 302 and 304. In a LTE system, a three-layer node network architecture including base station, radio network control unit and core network is simplified into a two-layer node architecture in which the function of the radio network control unit is assigned to the base station and a wired interface named “X2” is defined for coordination and communication between base stations.

In FIG. 2, the BSs 200-204 are also connected with each other via air interfaces, A1 interfaces, 310, 312 and 314. In a future communication system, it is possible to introduce a concept of relay node. Relay nodes are connected with each other via wireless interfaces and a base station can be considered as a special relay node. Thus, a wireless interface named “A1” can then be used for coordination and communication between base stations.

Additionally, an upper layer entity 220 of the BSs 200-204 is also shown in FIG. 2, which can be a gateway or another network entity such as mobility management entity. The upper layer entity 220 is connected to the BSs 200-204 via S1 interfaces 320, 322 and 324, respectively. In a LTE system, a wired interface named “S1” is defined for coordination and communication between the upper layer entity and the base station.

A number of User Equipments (UEs) 400-430 are distributed over the cells 100-104, as shown in FIG. 2. As known to those skilled in the art, each of the UEs 400-430 comprises a transmitter, a receiver and a mobile terminal control unit. Each of the UEs 400-430 can access the cellular communication system via its serving BS (one of the BSs 200-204). It should be understood that while only 16 UEs are illustratively shown in FIG. 2, there may be a large number of UEs in practice. In this sense, the description of the UEs in FIG. 2 is also for illustrative purpose only. Each of the UEs 400-430 can access the cellular communication network via its serving BS. The BS directly providing communication service to a certain UE is referred to as the serving BS of that UE, while other BSs are referred to non-serving BSs of that UE. The non-serving BSs can function as cooperative BSs of the serving BS and provide communication service to the UE along with the serving BS.

For explanation of this embodiment, the UE 416 is considered which is equipped with 2 receiving antennas and operates in a downlink multi-antenna multi-BS coordination mode. The UE 416 has BS 202 as its serving BS and has BSs 200 and 204 as its non-serving BSs. It is to be noted that this embodiment focuses on the UE 416, which does not imply that the present invention is only applicable to one UE scenario. Rather, the present invention is fully applicable to multi-UE scenario. For example, the inventive method can be applied to the UEs 408, 410, 430 and the like as shown in FIG. 2. In addition, in the scenario of this embodiment, there is one serving BS and two non-serving BSs. Of course, this does not mean that the present invention is limited to the particular constraints. In fact, the numbers of serving and non-serving BSs can be determined without any specific limitations.

In the specific instances of the description, a particular configuration for LTE system is considered, see 3GPP document TS 36.213 V8.3.0, “Evolved Universal Terrestrial Radio Access (E-UTRA); Physical Layer Procedures”, which defines 7 downlink MIMO data transmission approaches:

1) Single antenna transmission. One single antenna is used for signal transmission, which is a special instance of MIMO system. This approach can only transmit a single layer of data.

2) Transmission diversity. In a MIMO system, diversity effects of time and/or frequency can be utilized to transmit signals, so as to improve the reception quality of the signals. This approach can only transmit a single layer of data.

3) Open-loop space division multiplexing. This is a space division multiplexing without the need for spatial pre-coding information fed back from UE.

4) Closed-loop space division multiplexing. This is a space division multiplexing in which channel state information fed back from UE is required.

5) Multi-user MIMO. There are multiple UEs simultaneously participating in the downlink communication of the MIMO system.

6) Closed-loop single layer pre-coding. Only one single layer of data is transmitted using a pre-coding technology in the MIMO system.

7) Beam forming transmission. The beam forming technology is employed in the MIMO system. A dedicated reference signal is used for data demodulation at UE.

It is to be noted that, in the description of the present invention, when a transmission approach based on transmission diversity is employed at a UE's serving and non-serving BSs, the transmission diversity can be time diversity, frequency diversity, spatial diversity, phase delay diversity or any combination or extension of various diversity technologies. Moreover, the diversity preprocessing can be centralized or distributed. It is also to be noted that the use of downlink data transmission approaches defined in LTE system is only for the purpose of explaining the embodiments of the present invention and does not mean that the implementation of the present invention is limited to the above constraints.

In addition, according to 3GPP document TR 25.814 V1.5.0, “Physical Layer Aspects for Evolved UTRA”; R1-063013, “Approved minutes of 3GPP TSG RAN WG1 #46 in Tallinn”; and R1-080631, “Report of 3GPP TSG RAN WG1 #51 bis v1.0.0”, a downlink LTE system with a bandwidth of 20 MHz has approximately 100 spectral resource blocks in frequency domain. If the size of a frequency band equals to the size of the spectral resource block, the downlink LTE system with 20 MHz bandwidth will have approximately 100 frequency bands. If the size of a frequency band is four times as large as the size of the spectral resource block, then such a downlink LTE system will have around 25 frequency bands. Herein, it is to be noted that the definition for frequency band is exemplified for explaining the embodiments of the present invention only. The present invention is not limited to the above definition and is fully applicable to other definitions. By reading the embodiments of the present invention, those skilled in the art can understand that the solution of the present invention is applicable to a general definition of frequency band.

In description of the embodiment, the following multi-BS interference coordination scenario is assumed.

Exemplary Scenario: a UE in a cell feeds downlink channel information of the current BS and/or downlink channel information of the neighboring BSs back to the current BS. The feedback can be performed using specific feedback signaling or an uplink reference signal transmitted from the UE. There is a background interface communication between the BSs. The background interface refers to the X2 interfaces 300-304 and/or the air interfaces, or “A1 interfaces” 310-314 and/or the S1 interfaces 320-324. Further, the frequency of the background interface communication can be at most once per 20 ms.

It is to be noted that the conditions assumed in the exemplary scenario are illustrated for the purpose of explaining the embodiments of the present invention only. The present invention is not limited to the above assumption and is fully applicable to other assumptions. By reading the embodiments of the present invention, those skilled in the art can understand that the solution of the present invention is also applicable to a general situation.

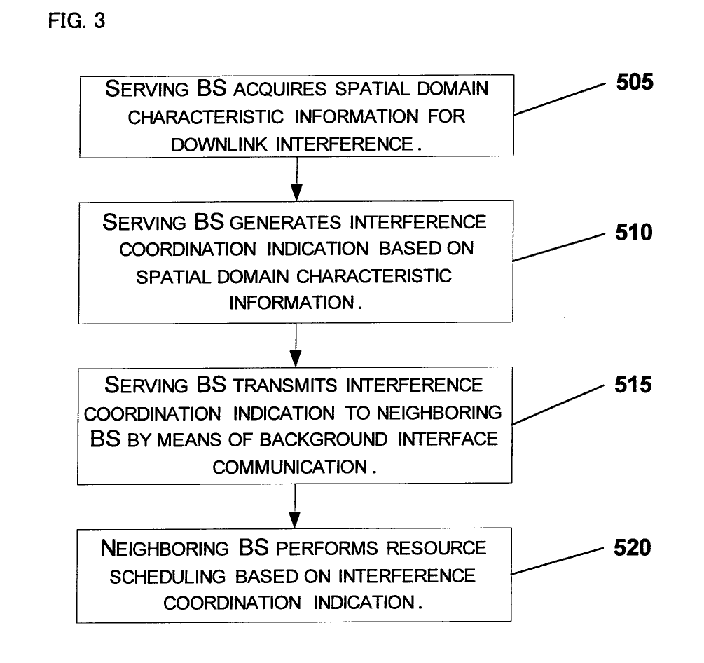

FIG. 3 is a flowchart illustrating the method for downlink multi-antenna multi-base station interference coordination according to an embodiment of the present invention.

As shown in FIG. 3, the method according to the embodiment of the invention comprises the following steps.

At step 505, a serving BS acquires spatial domain characteristic information for downlink interference.

A UE can transmit the spatial domain characteristic information for downlink interference to the serving BS by using specific feedback signaling. Alternatively, the UE can transmit an uplink reference signal to the serving BS such that the serving BS can acquire the spatial domain characteristic information for downlink interference.

At step 510, the serving BS generates an interference coordination indication based on the acquired spatial domain characteristic information for downlink interference.

Herein, the interference coordination indication can be used to indicate at least one of:

[1] information on a spatial domain beam to be used by the serving base station;

[2] information on a spatial domain beam which is not used or will no longer be used by the serving base station;

[3] information on a spatial domain beam which the serving base station does not desire a neighboring base station to use; and

[4] information on a spatial domain beam which the serving base station desires a neighboring base station to use.

Further, a number of spatial domain beams can be grouped into a spatial domain beam sub-space. In this case, the interference coordination indication can be used to indicate at least one of:

[1] information on a spatial domain beam sub-space to be used by the serving base station;

[2] information on a spatial domain beam sub-space which is not used or will no longer be used by the serving base station;

[3] information on a spatial domain beam sub-space which the serving base station does not desire a neighboring base station to use; and

[4] information on a spatial domain beam sub-space which the serving base station desires a neighboring base station to use.

The interference coordination indication can be a two-level indication using a bit string type of signaling.

Alternatively, the interference coordination indication can be a multi-level indication using an enumerative type of signaling.

Alternatively, the interference coordination indication can be a two-dimensional table with a first dimension representing spectral resource blocks and a second dimension representing spatial domain beams or spatial domain beam sub-spaces. Then, all the spectral resource blocks can be further merged into a full band, in which case the interference coordination indication can be simplified into a one-dimensional list containing only the spatial domain.

Alternatively, the interference coordination indication can be combined with the indication of the transmission power control based on spectral resource block as introduced in the above method 1), so as to constitute a two-dimensional spatial-frequency domain transmission power control indication.

Alternatively, the interference coordination indication can be a one-dimensional list, each element of which contains an index number for a spectral resource block concatenated with an index number for a spatial domain beam, or an index number for a spectral resource block concatenated with an index number for a spatial domain beam sub-space.

Additionally, the interference coordination indication may contain additional information indicating multi-user MIMO communication load. The additional information indicating multi-user MIMO communication load can be a spectral resource block based two-level indication using a bit string type of signaling. Alternatively, the additional information can be a spectral resource block based multi-level indication using an enumerative type of signaling.

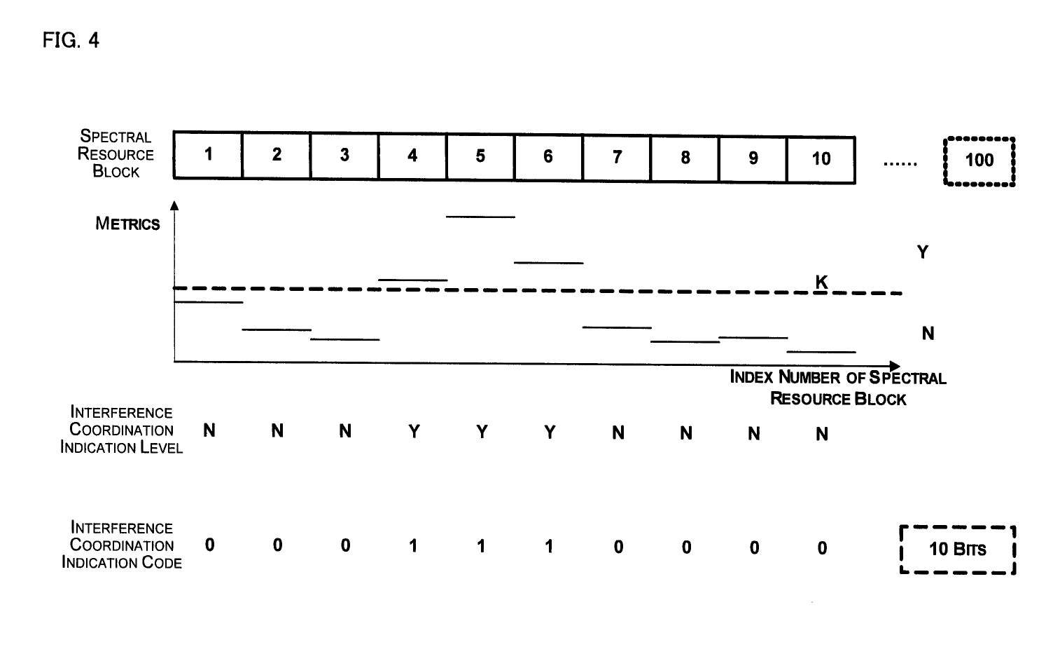

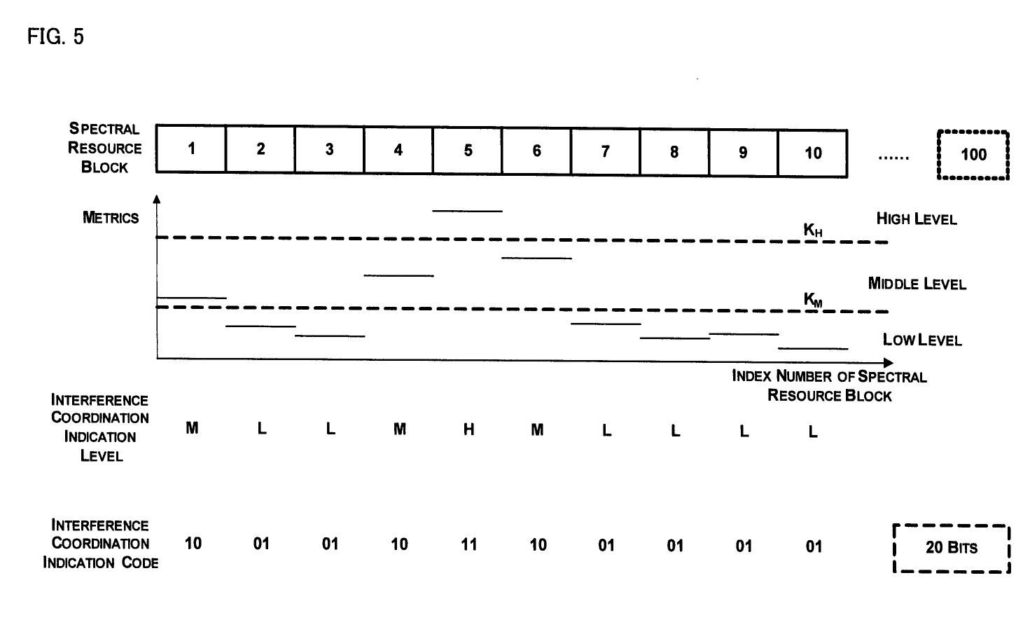

In this embodiment, 34 application examples are described using two indication forms which are illustrated in FIGS. 4 and 5, respectively.

In FIG. 4, it is assumed that only two-level interference coordination indication is considered and a condition C is used for determining the interference coordination indication (“Yes” indication or “No” indication). If the condition C is not satisfied, a “No” indication is generated; otherwise, a “Yes” indication is generated. In FIG. 4, the condition C can be any condition, such as energy strength threshold, scheduling frequency, service quality satisfaction threshold and the like. It is also to be noted that the condition C can be determined in a variety of manners. For example, the condition C can be determined by the upper layer network in configuration of the BS or determined by the individual BSs according to their own status, such as system load situation, interference situation, number of users on the border, etc. In addition, the BSs can communicate their conditions C to each other via their background interfaces, such that the BSs can have better understanding of the meaning of the interference coordination indication. Of course, the interference coordination indication can be implemented without exchanging the conditions among the BSs. Thus, in FIG. 4, the threshold K can be configured by the upper layer network, determined by the individual BSs independently, or exchanged among the BSs via their background interfaces. The spectral resource blocks 1-10 are considered. The interference coordination indication levels associated with the spectral resource blocks 1-10 are N, N, N, Y, Y, Y, N, N, N, N, respectively (where N denotes “No” indication while Y denotes “Yes” indication). These interference coordination indication levels can be encoded with the interference coordination indication coding table as shown in Table 1. In this way, the interference coordination indication codes associated with the spectral resource blocks 1-10 can be 0, 0, 0, 1, 1, 1, 0, 0, 0, 0.

TABLE 1
Interference Coordination Indication Coding Table

Interference
Coordination
Indication Level

| | N | Y |
|---|---|---|
| Interference Coordination Indication Code | 0 | 1 |

It is to be noted that the interference coordination indication coding as shown in Table 1 is only an example for the mapping between the interference coordination indication levels and the interference coordination indication codes. Other interference coordination indication coding approaches can be used in practical implementation of the present invention as long as there is a one-to-one mapping between the levels and the codes.

In FIG. 5, it is assumed that a multi-level (3-level in this example) interference coordination indication is considered and additional conditions C₁ and C₂ are used for determining the interference coordination indication (low-level, middle-level and high-level). If the condition C is not satisfied, a “No” indication is generated; otherwise, a “Yes” indication is generated, as noted above. Further, if the condition C₁ is not satisfied, a “low-level” indication is generated; if the condition C₁ is satisfied which the condition C₂ is not, a “middle-level” indication is generated; and if the condition C₂ is satisfied, a “high-level” indication is generated. In FIG. 5, the conditions C₁ and C₂ can be any condition, such as energy strength threshold, scheduling frequency, service quality satisfaction threshold and the like. It is also to be noted that the conditions C₁ and C₂ can be determined in a variety of manners. For example, the conditions C₁ and C₂ can be determined by the upper layer network in configuration of the BS or determined by the individual BSs according to their own status, such as system load situation, interference situation, number of users on the border, etc. In addition, the BSs can communicate their conditions C₁ and C₂ to each other via their background interfaces, such that the BSs can have better understanding of the meaning of the interference coordination indication. Of course, the interference coordination indication can be implemented without exchanging the conditions among the BSs. Thus, in FIG. 5, the thresholds KM and KH can be configured by the upper layer network, determined by the individual BSs independently, or exchanged among the BSs via their background interfaces.

Again, the spectral resource blocks 1-10 are considered. The interference coordination indication levels associated with the spectral resource blocks 1-10 are M, L, L, M, H, M, L, L, L, L, respectively (where L denotes “low-level” indication, M denotes “middle-level” indication and H denotes “high-level” indication). These interference coordination indication levels can be encoded with the interference coordination indication coding table as shown in Table 2. In this way, the interference coordination indication codes associated with the spectral resource blocks 1-10 can be 10, 01, 01, 10, 11, 10, 01, 01, 01, 01.

TABLE 2
Interference Coordination Indication Coding Table

| | Interference | | |
|---|---|---|---|
| | Coordination | | |
| | Indication Level | | |
| | L | M | H |
| Interference Coordination | 01 | 10 | 11 |
| Indication Code | | | |

It is to be noted that the interference coordination indication coding as shown in Table 2 is only an example for the mapping between the interference coordination indication levels and the interference coordination indication codes. Other interference coordination indication coding approaches can be used in practical implementation of the present invention as long as there is a one-to-one mapping between the levels and the codes.

Particularly, it is to be noted that, in FIGS. 4 and 5, the interference coordination analysis is carried out on each spectral resource block. In practice, however, the spectral resource blocks can be grouped into frequency bands and the interference coordination analysis can then be performed on per frequency band basis. In this way, a lower signaling overhead can be achieved. This embodiment does not preclude the implementation based on grouping of the spectral resource blocks. All the embodiments of the present invention can be implemented by replacing the index numbers of spectral resource blocks with the index numbers of the frequency bands and then considering the frequency bands as equivalent to the spectral resource blocks.

Next, the method for generating the interference coordination indication according to the present invention will be detailed with reference to specific instances. According to the present invention, the following data structures can be used for the interference coordination indication:

1) Two-dimensional table, using a sequence of interference coordination indications as signaling;

2) One-dimensional list, using index numbers of spectral resource blocks concatenated with index numbers of spatial domain beams/spatial domain beam sub-spaces as signaling; and/or

3) One-dimensional list, using a sequence of a number of concatenated index numbers of spatial domain beams/spatial domain beam sub-spaces as signaling.

### Example 1

### Two-Dimensional Table (Using a Sequence of Interference Coordination Indications Directly as Signaling)

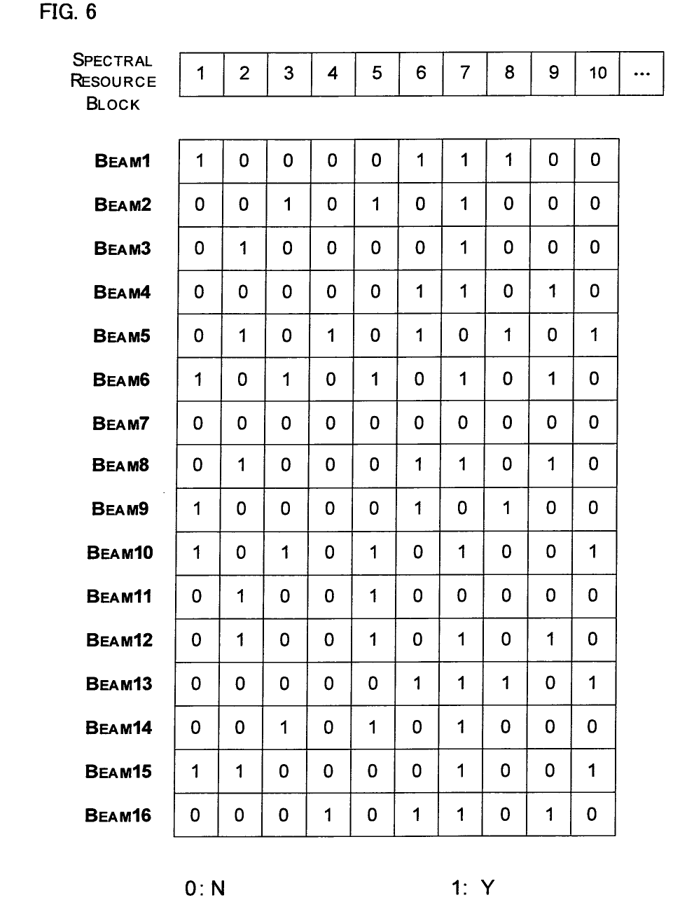

The interference coordination indication indicates information on a spatial domain beam likely to be used by the serving BS. FIG. 6 illustrates this embodiment which takes the indication form as shown in FIG. 4. It is assumed that there are 16 beams used for quantization partition of the spatial domain. For each of the spectral resource blocks 1-10, the interference coordination indication signaling associated with each spatial domain beam is a two-level indication using a bit string type of signaling. That is, “1” indicates that the beam at the corresponding location is likely to be used by the serving BS in the next 20 ms, while “0” indicates otherwise. Thus, the interference coordination indication signaling is formed by concatenation of the interference coordination indication bits corresponding to the spectral resource blocks 1-10. It is to be noted that this embodiment can be considered as an extended transmission power control based on spectral resource block if the signaling “1” is interpreted as indicating that the transmission power of the serving BS in a spatial domain beam corresponding to a spatial resource block will exceed a threshold in the next 20 ms.

### Example 2

### Two-Dimensional Table (Using a Sequence of Interference Coordination Indications Directly as Signaling)

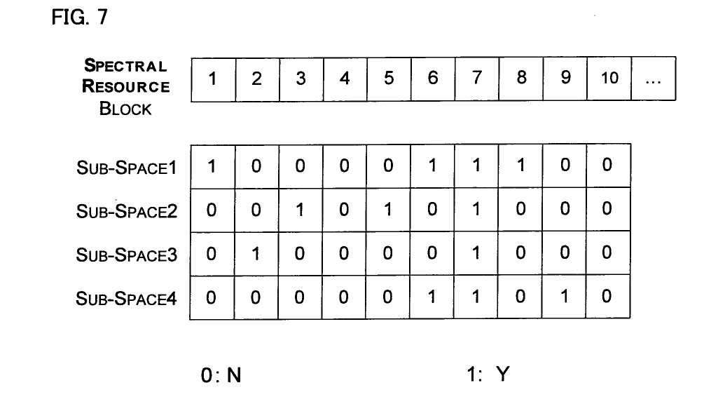

The interference coordination indication indicates information on a spatial domain beam sub-space likely to be used by the serving BS. FIG. 7 illustrates this embodiment which takes the indication form as shown in FIG. 4. It is assumed that 16 beams are grouped into 4 sub-spaces in advance. For each of the spectral resource blocks 1-10, the interference coordination indication signaling associated with each sub-space is a two-level indication using a bit string type of signaling. That is, “1” indicates that the sub-space at the corresponding location is likely to be used by the serving BS in the next 20 ms, while “0” indicates otherwise. Thus, the interference coordination indication signaling is formed by concatenation of the interference coordination indication bits corresponding to the spectral resource blocks 1-10. It is to be noted that this embodiment can be considered as an extended transmission power control based on spectral resource block if the signaling “1” is interpreted as indicating that the transmission power of the serving BS in a sub-space corresponding to a spatial resource block will exceed a threshold in the next 20 ms.

### Example 3

### Two-Dimensional Table (using a Sequence of Interference Coordination Indications Directly as Signaling)

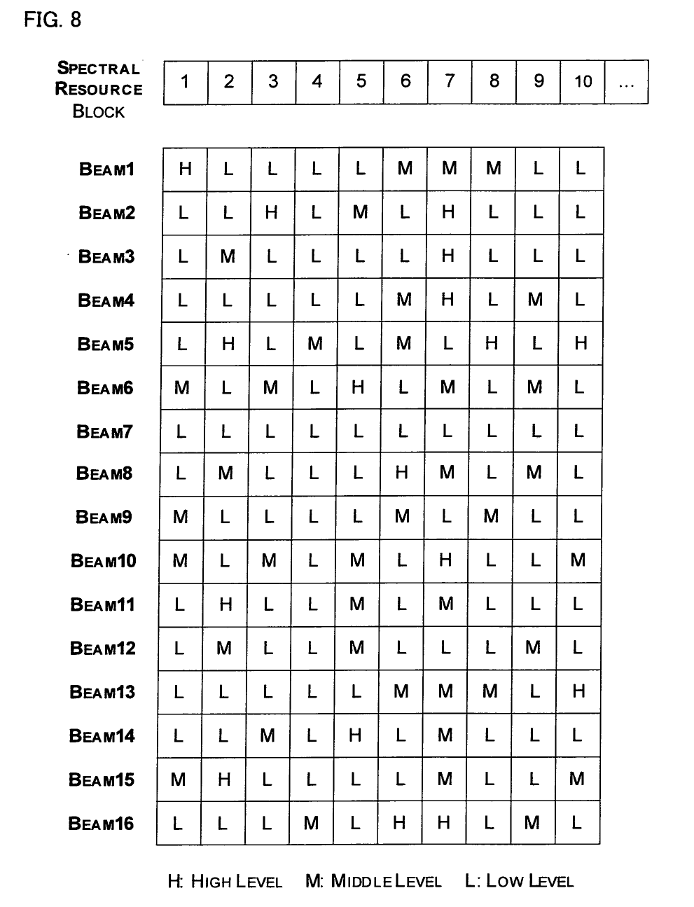

The interference coordination indication indicates information on a spatial domain beam likely to be used by the serving BS. FIG. 8 illustrates this embodiment which takes the indication form as shown in FIG. 5. It is assumed that there are 16 beams used for quantization partition of the spatial domain. For each of the spectral resource blocks 1-10, the interference coordination indication signaling associated with each spatial domain beam is a multi-level indication using an enumerative type of signaling. That is, “high” indicates that the beam at the corresponding location is highly likely to be used by the serving BS in the next 20 ms, “middle” indicates that the beam at the corresponding location is moderately likely to be used by the serving BS in the next 20 ms; and “low” indicates that the beam at the corresponding location is even less likely to be used by the serving BS in the next 20 ms. Thus, the interference coordination indication signaling is formed by concatenation of the interference coordination indication levels corresponding to the spectral resource blocks 1-10.

### Example 4

### Two-Dimensional Table (using a Sequence of Interference Coordination Indications Directly as Signaling)

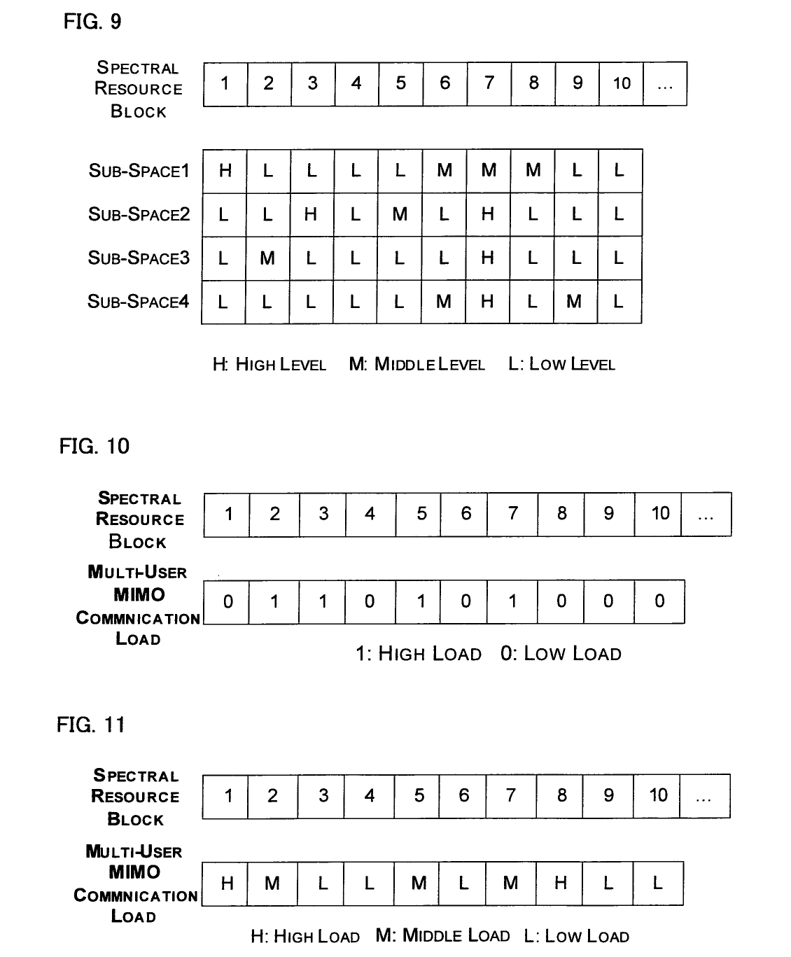

The interference coordination indication indicates information on a spatial domain beam sub-space likely to be used by the serving BS. FIG. 9 illustrates this embodiment which takes the indication form as shown in FIG. 5. It is assumed that 16 beams are grouped into 4 sub-spaces in advance. For each of the spectral resource blocks 1-10, the interference coordination indication signaling associated with each spatial domain beam sub-space is a multi-level indication using an enumerative type of signaling. That is, “high” indicates that the sub-space at the corresponding location is highly likely to be used by the serving BS in the next 20 ms; “middle” indicates that the sub-space at the corresponding location is moderately likely to be used by the serving BS in the next 20 ms; and “low” indicates that the sub-space at the corresponding location is even less likely to be used by the serving BS in the next 20 ms. Thus, the interference coordination indication signaling is formed by concatenation of the interference coordination indication levels corresponding to the spectral resource blocks 1-10.

### Example 5

### Two-Dimensional Table (using a Sequence of Interference Coordination Indications Directly as Signaling)

The interference coordination indication indicates information on a spatial domain beam unlikely to be used by the serving BS. FIG. 6 illustrates this embodiment which takes the indication form as shown in FIG. 4. It is assumed that there are 16 beams used for quantization partition of the spatial domain. For each of the spectral resource blocks 1-10, the interference coordination indication signaling associated with each spatial domain beam is a two-level indication using a bit string type of signaling. That is, “1” indicates that the beam at the corresponding location is unlikely to be used by the serving BS in the next 20 ms, while “0” indicates otherwise. Thus, the interference coordination indication signaling is formed by concatenation of the interference coordination indication bits corresponding to the spectral resource blocks 1-10. It is to be noted that this embodiment can be considered as an extended transmission power control based on spectral resource block if the signaling “1” is interpreted as indicating that the transmission power of the serving BS in a spatial domain beam corresponding to a spatial resource block will not exceed a threshold in the next 20 ms.

### Example 6

### Two-Dimensional Table (using a Sequence of Interference Coordination Indications Directly as Signaling)

The interference coordination indication indicates information on a spatial domain beam sub-space unlikely to be used by the serving BS. FIG. 7 illustrates this embodiment which takes the indication form as shown in FIG. 4. It is assumed that 16 beams are grouped into 4 sub-spaces in advance. For each of the spectral resource blocks 1-10, the interference coordination indication signaling associated with each sub-space is a two-level indication using a bit string type of signaling. That is, “1” indicates that the sub-space at the corresponding location is unlikely to be used by the serving BS in the next 20 ms, while “0” indicates otherwise. Thus, the interference coordination indication signaling is formed by concatenation of the interference coordination indication bits corresponding to the spectral resource blocks 1-10. It is to be noted that this embodiment can be considered as an extended transmission power control based on spectral resource block if the signaling “1” is interpreted as indicating that the transmission power of the serving BS in a sub-space corresponding to a spatial resource block will not exceed a threshold in the next 20 ms.

### Example 7

### Two-Dimensional Table (using a Sequence of Interference Coordination Indications Directly as Signaling)

The interference coordination indication indicates information on a spatial domain beam unlikely to be used by the serving BS. FIG. 8 illustrates this embodiment which takes the indication form as shown in FIG. 5. It is assumed that there are 16 beams used for quantization partition of the spatial domain. For each of the spectral resource blocks 1-10, the interference coordination indication signaling associated with each spatial domain beam is a multi-level indication using an enumerative type of signaling. That is, “high” indicates that the beam at the corresponding location is highly unlikely to be used by the serving BS in the next 20 ms; “middle” indicates that the beam at the corresponding location is moderately unlikely to be used by the serving BS in the next 20 ms; and “low” indicates that the beam at the corresponding location is even less unlikely to be used by the serving BS in the next 20 ms. Thus, the interference coordination indication signaling is formed by concatenation of the interference coordination indication levels corresponding to the spectral resource blocks 1-10.

### Example 8

### Two-Dimensional Table (using a Sequence of Interference Coordination Indications Directly as Signaling)

The interference coordination indication indicates information on a spatial domain beam sub-space unlikely to be used by the serving BS. FIG. 9 illustrates this embodiment which takes the indication form as shown in FIG. 5. It is assumed that 16 beams are grouped into 4 sub-spaces in advance. For each of the spectral resource blocks 1-10, the interference coordination indication signaling associated with each spatial domain beam sub-space is a multi-level indication using an enumerative type of signaling. That is, “high” indicates that the sub-space at the corresponding location is highly unlikely to be used by the serving BS in the next 20 ms; “middle” indicates that the sub-space at the corresponding location is moderately unlikely to be used by the serving BS in the next 20 ms; and “low” indicates that the sub-space at the corresponding location is even less unlikely to be used by the serving BS in the next 20 ms. Thus, the interference coordination indication signaling is formed by concatenation of the interference coordination indication levels corresponding to the spectral resource blocks 1-10.

### Example 9

### Two-Dimensional Table (using a Sequence of Interference Coordination Indications Directly as Signaling)

The interference coordination indication indicates information on a spatial domain beam the serving BS does not desire a neighboring BS to use. FIG. 6 illustrates this embodiment which takes the indication form as shown in FIG. 4. It is assumed that there are 16 beams used for quantization partition of the spatial domain. For each of the spectral resource blocks 1-10, the interference coordination indication signaling associated with each spatial domain beam is a two-level indication using a bit string type of signaling. That is, “1” indicates that the serving BS does not desire the neighboring BS to use the beam at the corresponding location in the next 20 ms, while “0” indicates otherwise. Thus, the interference coordination indication signaling is formed by concatenation of the interference coordination indication bits corresponding to the spectral resource blocks 1-10.

### Example 10

### Two-Dimensional Table (using a Sequence of Interference Coordination Indications Directly as Signaling)

The interference coordination indication indicates information on a spatial domain beam sub-space the serving BS does not desire a neighboring BS to use. FIG. 7 illustrates this embodiment which takes the indication form as shown in FIG. 4. It is assumed that 16 beams are grouped into 4 sub-spaces in advance. For each of the spectral resource blocks 1-10, the interference coordination indication signaling associated with each sub-space is a two-level indication using a bit string type of signaling. That is, “1” indicates that the serving BS does not desire the neighboring BS to use the sub-space at the corresponding location in the next 20 ms, while “0” indicates otherwise. Thus, the interference coordination indication signaling is formed by concatenation of the interference coordination indication bits corresponding to the spectral resource blocks 1-10.

### Example 11

### Two-Dimensional Table (using a Sequence of Interference Coordination Indications Directly as Signaling)

The interference coordination indication indicates information on a spatial domain beam the serving BS does not desire a neighboring BS to use. FIG. 8 illustrates this embodiment which takes the indication form as shown in FIG. 5. It is assumed that there are 16 beams used for quantization partition of the spatial domain. For each of the spectral resource blocks 1-10, the interference coordination indication signaling associated with each spatial domain beam is a multi-level indication using an enumerative type of signaling. That is, “high” indicates that the serving BS does not desire, to a high extent, the neighboring BS to use the beam at the corresponding location in the next 20 ms; “middle” indicates that the serving BS does not desire, to a moderate extent, the neighboring BS to use the beam at the corresponding location in the next 20 ms; and “low” indicates that the serving BS does not desire, to a low extent, the neighboring BS to use the beam at the corresponding location in the next 20 ms. Thus, the interference coordination indication signaling is formed by concatenation of the interference coordination indication levels corresponding to the spectral resource blocks 1-10.

### Example 12

### Two-Dimensional Table (using a Sequence of Interference Coordination Indications Directly as Signaling)

The interference coordination indication indicates information on a spatial domain beam sub-space the serving BS does not desire a neighboring BS to use. FIG. 9 illustrates this embodiment which takes the indication form as shown in FIG. 5. It is assumed that there are 16 beams used for quantization partition of the spatial domain. For each of the spectral resource blocks 1-10, the interference coordination indication signaling associated with each spatial domain beam sub-space is a multi-level indication using an enumerative type of signaling. That is, “high” indicates that the serving BS does not desire, to a high extent, the neighboring BS to use the sub-space at the corresponding location in the next 20 ms; “middle” indicates that the serving BS does not desire, to a moderate extent, the neighboring BS to use the sub-space at the corresponding location in the next 20 ms; and “low” indicates that the serving BS does not desire, to a low extent, the neighboring BS to use the sub-space at the corresponding location in the next 20 ms. Thus, the interference coordination indication signaling is formed by concatenation of the interference coordination indication levels corresponding to the spectral resource blocks 1-10.

### Example 13

### Two-Dimensional Table (using a Sequence of Interference Coordination Indications Directly as Signaling)

The interference coordination indication indicates information on a spatial domain beam the serving BS desires a neighboring BS to use. FIG. 6 illustrates this embodiment which takes the indication form as shown in FIG. 4. It is assumed that there are 16 beams used for quantization partition of the spatial domain. For each of the spectral resource blocks 1-10, the interference coordination indication signaling associated with each spatial domain beam is a two-level indication using a bit string type of signaling. That is, “1” indicates that the serving BS desires the neighboring BS to use the beam at the corresponding location in the next 20 ms, while “0” indicates otherwise. Thus, the interference coordination indication signaling is formed by concatenation of the interference coordination indication bits corresponding to the spectral resource blocks 1-10.

### Example 14

### Two-Dimensional Table (using a Sequence of Interference Coordination Indications Directly as Signaling)

The interference coordination indication indicates information on a spatial domain beam sub-space the serving BS desires a neighboring BS to use. FIG. 7 illustrates this embodiment which takes the indication form as shown in FIG. 4. It is assumed that 16 beams are grouped into 4 sub-spaces in advance. For each of the spectral resource blocks 1-10, the interference coordination indication signaling associated with each sub-space is a two-level indication using a bit string type of signaling. That is, “1” indicates that the serving BS desires the neighboring BS to use the sub-space at the corresponding location in the next 20 ms, while “0” indicates otherwise. Thus, the interference coordination indication signaling is formed by concatenation of the interference coordination indication bits corresponding to the spectral resource blocks 1-10.

### Example 15

### Two-Dimensional Table (using a Sequence of Interference Coordination Indications Directly as Signaling)

The interference coordination indication indicates information on a spatial domain beam the serving BS desires a neighboring BS to use. FIG. 8 illustrates this embodiment which takes the indication form as shown in FIG. 5. It is assumed that there are 16 beams used for quantization partition of the spatial domain. For each of the spectral resource blocks 1-10, the interference coordination indication signaling associated with each spatial domain beam is a multi-level indication using an enumerative type of signaling. That is, “high” indicates that the serving BS desires, to a high extent, the neighboring BS to use the beam at the corresponding location in the next 20 ms; “middle” indicates that the serving BS desires, to a moderate extent, the neighboring BS to use the beam at the corresponding location in the next 20 ms; and “low” indicates that the serving BS desires, to a low extent, the neighboring BS to use the beam at the corresponding location in the next 20 ms. Thus, the interference coordination indication signaling is formed by concatenation of the interference coordination indication levels corresponding to the spectral resource blocks 1-10.

### Example 16

### Two-Dimensional Table (using a Sequence of Interference Coordination Indications Directly as Signaling)

The interference coordination indication indicates information on a spatial domain beam sub-space the serving BS desires a neighboring BS to use. FIG. 9 illustrates this embodiment which takes the indication form as shown in FIG. 5. It is assumed that there are 16 beams used for quantization partition of the spatial domain. For each of the spectral resource blocks 1-10, the interference coordination indication signaling associated with each spatial domain beam sub-space is a multi-level indication using an enumerative type of signaling. That is, “high” indicates that the serving BS desires, to a high extent, the neighboring BS to use the sub-space at the corresponding location in the next 20 ms; “middle” indicates that the serving BS desires, to a moderate extent, the neighboring BS to use the sub-space at the corresponding location in the next 20 ms, and “low” indicates that the serving BS desires, to a low extent, the neighboring BS to use the sub-space at the corresponding location in the next 20 ms. Thus, the interference coordination indication signaling is formed by concatenation of the interference coordination indication levels corresponding to the spectral resource blocks 1-10.

### Example 17

### One-Dimensional List (using Index Numbers of Spectral Resource Blocks Concatenated with Index Numbers of Spatial Domain Beams as Signaling)

The index number of the spectral resource block having the highest level of interference coordination indication is concatenated with the index number of the corresponding spatial domain beam. Then, a set of all such signaling having the highest level of interference coordination indication can be used as the interference coordination indication.

The interference coordination indication indicates information on a spatial domain beam likely to be used by the serving BS. FIG. 8 illustrates the interference coordination indications which take the indication form as shown in FIG. 5. It is assumed that there are 16 beams used for quantization partition of the spatial domain. For each of the spectral resource blocks 1-10, the interference coordination indication signaling associated with each spatial domain beam is a multi-level indication using an enumerative type of signaling. That is, “high” indicates that the beam at the corresponding location is highly likely to be used by the serving BS in the next 20 ms; “middle” indicates that the beam at the corresponding location is moderately likely to be used by the serving BS in the next 20 ms; and “low” indicates that the beam at the corresponding location is even less likely to be used by the serving BS in the next 20 ms. In this embodiment, only the spectral resource blocks having the highest level of interference coordination indication are signaled, including spectral resource block 1-beam 1, spectral resource block 2-beam 5, spectral resource block 2-beam 11, spectral resource block 2-beam 15, spectral resource block 3-beam 2, spectral resource block 5-beam 6, spectral resource block 5-beam 14, spectral resource block 6-beam 8, spectral resource block 6-beam 16, spectral resource block 7-beam 2, spectral resource block 7-beam 3, spectral resource block 7-beam 4, spectral resource block 7-beam 10, spectral resource block 7-beam 16, spectral resource block 8-beam 5, spectral resource block 10-beam 5 and spectral resource block 10-beam 13. In this way, the resulting interference coordination indication is as follows:

1-1∥2-5∥2-11∥2-15∥3-2∥5-6∥5-14∥6-8∥6-16∥7-2∥7-3∥7-4∥7-10∥7-16∥8-5∥10-5∥10-13

where symbols “-” and “∥” each denotes a simple concatenation only and the respective expressions do not exist in actual transmission of the interference coordination indication.

### Example 18

### One-Dimensional List (using Index Numbers of Spectral Resource Blocks Concatenated with Index Numbers of Spatial Domain Beam Sub-Spaces as Signaling)

The index number of the spectral resource block having the highest level of interference coordination indication is concatenated with the index number of the corresponding spatial domain beam sub-space. Then, a set of all such signaling having the highest level of interference coordination indication can be used as the interference coordination indication.

The interference coordination indication indicates information on a spatial domain beam sub-space likely to be used by the serving BS. FIG. 9 illustrates the interference coordination indications which take the indication form as shown in FIG. 5. It is assumed that 16 beams are grouped into 4 sub-spaces. For each of the spectral resource blocks 1-10, the interference coordination indication signaling associated with each spatial domain beam is a multi-level indication using an enumerative type of signaling. That is, “high” indicates that the sub-space at the corresponding location is highly likely to be used by the serving BS in the next 20 ms; “middle” indicates that the sub-space at the corresponding location is moderately likely to be used by the serving BS in the next 20 ms; and “low” indicates that the sub-space at the corresponding location is even less likely to be used by the serving BS in the next 20 ms. In this embodiment, only the spectral resource blocks having the highest level of interference coordination indication are signaled, including spectral resource block 1-sub-space 1, spectral resource block 3-sub-space 2, spectral resource block 7-sub-space 2, spectral resource block 7-sub-space 3 and spectral resource block 7-sub-space 4. In this way, the resulting interference coordination indication is as follows:

1-1∥3-2∥7-2∥7-3∥7-4

where symbols “-” and “∥” each denotes a simple concatenation only and the respective expressions do not exist in actual transmission of the interference coordination indication.

### Example 19

### One-Dimensional List (using Index Numbers of Spectral Resource Blocks Concatenated with Index Numbers of Spatial Domain Beams as Signaling)

The index number of the spectral resource block having the highest level of interference coordination indication is concatenated with the index number of the corresponding spatial domain beam. Then, a set of all such signaling having the highest level of interference coordination indication can be used as the interference coordination indication.

The interference coordination indication indicates information on a spatial domain beam unlikely to be used by the serving BS. FIG. 8 illustrates the interference coordination indications which take the indication form as shown in FIG. 5. It is assumed that there are 16 beams used for quantization partition of the spatial domain. For each of the spectral resource blocks 1-10, the interference coordination indication signaling associated with each spatial domain beam is a multi-level indication using an enumerative type of signaling. That is, “high” indicates that the beam at the corresponding location is highly unlikely to be used by the serving BS in the next 20 ms; “middle” indicates that the beam at the corresponding location is moderately unlikely to be used by the serving BS in the next 20 ms; and “low” indicates that the beam at the corresponding location is even less unlikely to be used by the serving BS in the next 20 ms. In this embodiment, only the spectral resource blocks having the highest level of interference coordination indication are signaled, including spectral resource block 1-beam 1, spectral resource block 2-beam 5, spectral resource block 2-beam 11, spectral resource block 2-beam 15, spectral resource block 3-beam 2, spectral resource block 5-beam 6, spectral resource block 5-beam 14, spectral resource block 6-beam 8, spectral resource block 6-beam 16, spectral resource block 7-beam 2, spectral resource block 7-beam 3, spectral resource block 7-beam 4, spectral resource block 7-beam 10, spectral resource block 7-beam 16, spectral resource block 8-beam 5, spectral resource block 10-beam 5 and spectral resource block 10-beam 13. In this way, the resulting interference coordination indication is as follows:

1-1∥2-5∥2-11∥2-15∥3-2∥5-6∥5-14∥6-8∥6-16∥7-2∥7-3∥7-4∥7-10∥7-16∥8-5∥10-5∥10-13

where symbols “-” and “∥” each denotes a simple concatenation only and the respective expressions do not exist in actual transmission of the interference coordination indication.

### Example 20

### One-Dimensional List (using Index Numbers of Spectral Resource Blocks Concatenated with Index Numbers of Spatial Domain Beam Sub-Spaces as Signaling)

The index number of the spectral resource block having the highest level of interference coordination indication is concatenated with the index number of the corresponding spatial domain beam sub-space. Then, a set of all such signaling having the highest level of interference coordination indication can be used as the interference coordination indication.

The interference coordination indication indicates information on a spatial domain beam sub-space unlikely to be used by the serving BS. FIG. 9 illustrates the interference coordination indications which take the indication form as shown in FIG. 5. It is assumed that 16 beams are grouped into 4 sub-spaces. For each of the spectral resource blocks 1-10, the interference coordination indication signaling associated with each spatial domain beam is a multi-level indication using an enumerative type of signaling. That is, “high” indicates that the sub-space at the corresponding location is highly unlikely to be used by the serving BS in the next 20 ms; “middle” indicates that the sub-space at the corresponding location is moderately unlikely to be used by the serving BS in the next 20 ms; and “low” indicates that the sub-space at the corresponding location is even less unlikely to be used by the serving BS in the next 20 ms. In this embodiment, only the spectral resource blocks having the highest level of interference coordination indication are signaled, including spectral resource block 1-sub-space 1, spectral resource block 3-sub-space 2, spectral resource block 7-sub-space 2, spectral resource block 7-sub-space 3 and spectral resource block 7-sub-space 4. In this way, the resulting interference coordination indication is as follows:

1-1∥3-2∥7-2∥7-3∥7-4

where symbols “-” and “∥” each denotes a simple concatenation only and the respective expressions do not exist in actual transmission of the interference coordination indication.

### Example 21

### One-Dimensional List (using Index Numbers of Spectral Resource Blocks Concatenated with Index Numbers of Spatial Domain Beams as Signaling)

The index number of the spectral resource block having the highest level of interference coordination indication is concatenated with the index number of the corresponding spatial domain beam. Then, a set of all such signaling having the highest level of interference coordination indication can be used as the interference coordination indication.

The interference coordination indication indicates information on a spatial domain beam the serving BS does not desire a neighboring BS to use. FIG. 8 illustrates the interference coordination indications which take the indication form as shown in FIG. 5. It is assumed that there are 16 beams used for quantization partition of the spatial domain. For each of the spectral resource blocks 1-10, the interference coordination indication signaling associated with each spatial domain beam is a multi-level indication using an enumerative type of signaling. That is, “high” indicates that the serving BS does not desire, to a high extent, the neighboring BS to use the beam at the corresponding location in the next 20 ms; “middle” indicates that the serving BS does not desire, to a moderate extent, the neighboring BS to use the beam at the corresponding location in the next 20 ms; and “low” indicates that the serving BS does not desire, to a low extent, the neighboring BS to use the beam at the corresponding location in the next 20 ms. In this embodiment, only the spectral resource blocks having the highest level of interference coordination indication are signaled, including spectral resource block 1-beam 1, spectral resource block 2-beam 5, spectral resource block 2-beam 11, spectral resource block 2-beam 15, spectral resource block 3-beam 2, spectral resource block 5-beam 6, spectral resource block 5-beam 14, spectral resource block 6-beam 8, spectral resource block 6-beam 16, spectral resource block 7-beam 2, spectral resource block 7-beam 3, spectral resource block 7-beam 4, spectral resource block 7-beam 10, spectral resource block 7-beam 16, spectral resource block 8-beam 5, spectral resource block 10-beam 5 and spectral resource block 10-beam 13. In this way, the resulting interference coordination indication is as follows:

1-1∥2-5∥2-11∥2-15∥3-2∥5-6∥5-14∥6-8∥6-16∥7-2∥7-3∥7-4∥7-10∥7-16∥8-5∥10-5∥10-13

where symbols “-” and “∥” each denotes a simple concatenation only and the respective expressions do not exist in actual transmission of the interference coordination indication.

### Example 22

### One-Dimensional List (using Index Numbers of Spectral Resource Blocks Concatenated with Index Numbers of Spatial Domain Beam Sub-Spaces as Signaling)

The index number of the spectral resource block having the highest level of interference coordination indication is concatenated with the index number of the corresponding spatial domain beam sub-space. Then, a set of all such signaling having the highest level of interference coordination indication can be used as the interference coordination indication.

The interference coordination indication indicates information on a spatial domain beam sub-space the serving BS does not desire a neighboring BS to use. FIG. 9 illustrates the interference coordination indications which take the indication form as shown in FIG. 5. It is assumed that 16 beams are grouped into 4 sub-spaces. For each of the spectral resource blocks 1-10, the interference coordination indication signaling associated with each spatial domain beam is a multi-level indication using an enumerative type of signaling. That is, “high” indicates that the serving BS does not desire, to a high extent, the neighboring BS to use the sub-space at the corresponding location in the next 20 ms, “middle” indicates that the serving BS does not desire, to a moderate extent, the neighboring BS to use the sub-space at the corresponding location in the next 20 ms; and “low” indicates that the serving BS does not desire, to a low extent, the neighboring BS to use the sub-space at the corresponding location in the next 20 ms. In this embodiment, only the spectral resource blocks having the highest level of interference coordination indication are signaled, including spectral resource block 1-sub-space 1, spectral resource block 3-sub-space 2, spectral resource block 7-sub-space 2, spectral resource block 7-sub-space 3 and spectral resource block 7-sub-space 4. In this way, the resulting interference coordination indication is as follows:

1-1∥3-2∥7-2∥7-3∥7-4

where symbols “-” and “∥” each denotes a simple concatenation only and the respective expressions do not exist in actual transmission of the interference coordination indication.

### Example 23

### One-Dimensional List (using Index Numbers of Spectral Resource Blocks Concatenated with Index Numbers of Spatial Domain Beams as Signaling)

The index number of the spectral resource block having the highest level of interference coordination indication is concatenated with the index number of the corresponding spatial domain beam. Then, a set of all such signaling having the highest level of interference coordination indication can be used as the interference coordination indication.

The interference coordination indication indicates information on a spatial domain beam the serving BS desires a neighboring BS to use. FIG. 8 illustrates the interference coordination indications which take the indication form as shown in FIG. 5. It is assumed that there are 16 beams used for quantization partition of the spatial domain. For each of the spectral resource blocks 1-10, the interference coordination indication signaling associated with each spatial domain beam is a multi-level indication using an enumerative type of signaling. That is, “high” indicates that the serving BS desires, to a high extent, the neighboring BS to use the beam at the corresponding location in the next 20 ms; “middle” indicates that the serving BS desires, to a moderate extent, the neighboring BS to use the beam at the corresponding location in the next 20 ms; and “low” indicates that the serving BS desires, to a low extent, the neighboring BS to use the beam at the corresponding location in the next 20 ms. In this embodiment, only the spectral resource blocks having the highest level of interference coordination indication are signaled, including spectral resource block 1-beam 1, spectral resource block 2-beam 5, spectral resource block 2-beam 11, spectral resource block 2-beam 15, spectral resource block 3-beam 2, spectral resource block 5-beam 6, spectral resource block 5-beam 14, spectral resource block 6-beam 8, spectral resource block 6-beam 16, spectral resource block 7-beam 2, spectral resource block 7-beam 3, spectral resource block 7-beam 4, spectral resource block 7-beam 10, spectral resource block 7-beam 16, spectral resource block 8-beam 5, spectral resource block 10-beam 5 and spectral resource block 10-beam 13. In this way, the resulting interference coordination indication is as follows:

1-1∥2-5∥2-11∥2-15∥3-2∥5-6∥5-14∥6-8∥6-16∥7-2∥7-3∥7-4∥7-10∥7-16∥8-5∥10-5∥10-13

where symbols “-” and “∥” each denotes a simple concatenation only and the respective expressions do not exist in actual transmission of the interference coordination indication.

### Example 24

### One-Dimensional List (using Index Numbers of Spectral Resource Blocks Concatenated with Index Numbers of Spatial Domain Beam Sub-Spaces as Signaling)

The index number of the spectral resource block having the highest level of interference coordination indication is concatenated with the index number of the corresponding spatial domain beam sub-space. Then, a set of all such signaling having the highest level of interference coordination indication can be used as the interference coordination indication.

The interference coordination indication indicates information on a spatial domain beam sub-space the serving BS desires a neighboring BS to use. FIG. 9 illustrates the interference coordination indications which take the indication form as shown in FIG. 5. It is assumed that 16 beams are grouped into 4 sub-spaces. For each of the spectral resource blocks 1-10, the interference coordination indication signaling associated with each spatial domain beam is a multi-level indication using an enumerative type of signaling. That is, “high” indicates that the serving BS desires, to a high extent, the neighboring BS to use the sub-space at the corresponding location in the next 20 ms; “middle” indicates that the serving BS desires, to a moderate extent, the neighboring BS to use the sub-space at the corresponding location in the next 20 ms; and “low” indicates that the serving BS desires, to a low extent, the neighboring BS to use the sub-space at the corresponding location in the next 20 ms. In this embodiment, only the spectral resource blocks having the highest level of interference coordination indication are signaled, including spectral resource block 1-sub-space 1, spectral resource block 3-sub-space 2, spectral resource block 7-sub-space 2, spectral resource block 7-sub-space 3 and spectral resource block 7-sub-space 4. In this way, the resulting interference coordination indication is as follows:

1-1∥3-2∥7-2∥7-3∥7-4

where symbols “-” and “∥” each denotes a simple concatenation only and the respective expressions do not exist in actual transmission of the interference coordination indication.

### Example 25

### One-Dimensional List (using a Sequence of a Number of Concatenated Index Numbers of Spatial Domain Beams as Signaling)

For each spectral resource block, the index numbers of the spatial domain beams corresponding to a number of interference coordination indications having relatively higher levels are concatenated with each other. Then, a set of such signaling for all of the spectral resource blocks can be used as the interference coordination indication.

The interference coordination indication indicates information on a spatial domain beam likely to be used by the serving BS. FIG. 8 illustrates the interference coordination indications which take the indication form as shown in FIG. 5. It is assumed that there are 16 beams used for quantization partition of the spatial domain. For each of the spectral resource blocks 1-10, the interference coordination indication signaling associated with each spatial domain beam is a multi-level indication using an enumerative type of signaling. That is, “high” indicates that the beam at the corresponding location is highly likely to be used by the serving BS in the next 20 ms; “middle” indicates that the beam at the corresponding location is moderately likely to be used by the serving BS in the next 20 ms; and “low” indicates that the beam at the corresponding location is even less likely to be used by the serving BS in the next 20 ms. In this embodiment, for each spectral resource block, the index numbers of four spatial domain beams corresponding to relatively higher levels of interference coordination indications are selected for concatenation, including: beam 1 (high)-beam 6 (middle)-beam 10 (middle)-beam 15 (middle) for spectral resource block 1; beam 5 (high)-beam 11 (high)-beam 12 (middle)-beam 15 (high) for spectral resource block 2; beam 2 (high)-beam 6 (middle)-beam 10 (middle)-beam 14 (middle) for spectral resource block 3; beam 5 (middle)-beam 8 (low)-beam 13 (low)-beam 16 (middle) for spectral resource block 4; beam 2 (middle)-beam 6 (high)-beam 12 (middle)-beam 14 (high) for spectral resource block 5; beam 1 (middle)-beam 5 (middle)-beam 8 (high)-beam 16 (high) for spectral resource block 6; beam 2 (high)-beam 3 (high)-beam 4 (high)-beam 10 (high) for spectral resource block 7; beam 1 (middle)-beam 5 (high)-beam 9 (middle)-beam 13 (middle) for spectral resource block 8; beam 4 (middle)-beam 6 (middle)-beam 8 (middle)-beam 12 (middle) for spectral resource block 9; and beam 5 (high)-beam 10 (middle)-beam 13 (high)-beam 15 (middle) for spectral resource block 10. In this way, the resulting interference coordination indication is as follows:

1-6-11-15∥5-11-12-15∥2-6-10-14∥5-8-13-16∥2-6-12-14∥1-5-8-16∥2-3-4-10∥1-5-9-13∥4-6-8-12∥5-10-13-15

where symbols “-” and “∥” each denotes a simple concatenation only and the respective expressions do not exist in actual transmission of the interference coordination indication.

### Example 26

### One-Dimensional List (using a Sequence of a Number of Concatenated Index Numbers of Spatial Domain Beam Sub-Spaces as Signaling)

For each spectral resource block, the index numbers of the spatial domain beam sub-spaces corresponding to a number of interference coordination indications having relatively higher levels are concatenated with each other. Then, a set of such signaling for all of the spectral resource blocks can be used as the interference coordination indication.

The interference coordination indication indicates information on a spatial domain beam likely to be used by the serving BS. FIG. 9 illustrates the interference coordination indications which take the indication form as shown in FIG. 5. It is assumed that there are 16 beams used for quantization partition of the spatial domain. For each of the spectral resource blocks 1-10, the interference coordination indication signaling associated with each spatial domain beam sub-space is a multi-level indication using an enumerative type of signaling. That is, “high” indicates that the sub-space at the corresponding location is highly likely to be used by the serving BS in the next 20 ms; “middle” indicates that the sub-space at the corresponding location is moderately likely to be used by the serving BS in the next 20 ms; and “low” indicates that the sub-space at the corresponding location is even less likely to be used by the serving BS in the next 20 ms. In this embodiment, for each spectral resource block, the index number of one spatial domain beam sub-space corresponding to relatively higher level of interference coordination indication is selected for concatenation, including: sub-space 1 (high) for spectral resource block 1; sub-space 3 (middle) for spectral resource block 2; sub-space 2 (high) for spectral resource block 3; sub-space 3 (low) for spectral resource block 4; sub-space 2 (middle) for spectral resource block 5; sub-space 1 (middle) for spectral resource block 6; sub-space 2 (high) for spectral resource block 7; sub-space 1 (middle) for spectral resource block 8; sub-space 4 (middle) for spectral resource block 9; and sub-space 1 (low) for spectral resource block 10. In this way, the resulting interference coordination indication is as follows:

1∥3∥2∥3∥2∥1∥2∥1∥4∥1

where symbol “∥” each denote a simple concatenation only and the respective expressions do not exist in actual transmission of the interference coordination indication.

### Example 27

### One-Dimensional List (using a Sequence of a Number of Concatenated Index Numbers of Spatial Domain Beams as Signaling)

For each spectral resource block, the index numbers of the spatial domain beams corresponding to a number of interference coordination indications having relatively higher levels are concatenated with each other. Then, a set of such signaling for all of the spectral resource blocks can be used as the interference coordination indication.

The interference coordination indication indicates information on a spatial domain beam unlikely to be used by the serving BS. FIG. 8 illustrates the interference coordination indications which take the indication form as shown in FIG. 5. It is assumed that there are 16 beams used for quantization partition of the spatial domain. For each of the spectral resource blocks 1-10, the interference coordination indication signaling associated with each spatial domain beam is a multi-level indication using an enumerative type of signaling. That is, “high” indicates that the beam at the corresponding location is highly unlikely to be used by the serving BS in the next 20 ms; “middle” indicates that the beam at the corresponding location is moderately unlikely to be used by the serving BS in the next 20 ms; and “low” indicates that the beam at the corresponding location is even less unlikely to be used by the serving BS in the next 20 ms. In this embodiment, for each spectral resource block, the index numbers of four spatial domain beams corresponding to relatively higher levels of interference coordination indications are selected for concatenation, including: beam 1 (high)-beam 6 (middle)-beam 10 (middle)-beam 15 (middle) for spectral resource block 1; beam 5 (high)-beam 11 (high)-beam 12 (middle)-beam 15 (high) for spectral resource block 2; beam 2 (high)-beam 6 (middle)-beam 10 (middle)-beam 14 (middle) for spectral resource block 3; beam 5 (middle)-beam 8 (low)-beam 13 (low)-beam 16 (middle) for spectral resource block 4; beam 2 (middle)-beam 6 (high)-beam 12 (middle)-beam 14 (high) for spectral resource block 5; beam 1 (middle)-beam 5 (middle)-beam 8 (high)-beam 16 (high) for spectral resource block 6; beam 2 (high)-beam 3 (high)-beam 4 (high)-beam 10 (high) for spectral resource block 7; beam 1 (middle)-beam 5 (high)-beam 9 (middle)-beam 13 (middle) for spectral resource block 8; beam 4 (middle)-beam 6 (middle)-beam 8 (middle)-beam 12 (middle) for spectral resource block 9; and beam 5 (high)-beam 10 (middle)-beam 13 (high)-beam 15 (middle) for spectral resource block 10. In this way, the resulting interference coordination indication is as follows:

1-6-11-15∥5-11-12-15∥2-6-10-14∥5-8-13-16∥2-6-12-14∥1-5-8-16∥2-3-4-10∥1-5-9-13∥4-6-8-12∥5-10-13-15

where symbols “-” and “∥” each denotes a simple concatenation only and the respective expressions do not exist in actual transmission of the interference coordination indication.

### Example 28

### One-Dimensional List (using a Sequence of a Number of Concatenated Index Numbers of Spatial Domain Beam Sub-Spaces as Signaling)

For each spectral resource block, the index numbers of the spatial domain beam sub-spaces corresponding to a number of interference coordination indications having relatively higher levels are concatenated with each other. Then, a set of such signaling for all of the spectral resource blocks can be used as the interference coordination indication.

The interference coordination indication indicates information on a spatial domain beam unlikely to be used by the serving BS. FIG. 9 illustrates the interference coordination indications which take the indication form as shown in FIG. 5. It is assumed that there are 16 beams used for quantization partition of the spatial domain. For each of the spectral resource blocks 1-10, the interference coordination indication signaling associated with each spatial domain beam sub-space is a multi-level indication using an enumerative type of signaling. That is, “high” indicates that the sub-space at the corresponding location is highly unlikely to be used by the serving BS in the next 20 ms; “middle” indicates that the sub-space at the corresponding location is moderately unlikely to be used by the serving BS in the next 20 ms; and “low” indicates that the sub-space at the corresponding location is even less unlikely to be used by the serving BS in the next 20 ms. In this embodiment, for each spectral resource block, the index number of one spatial domain beam sub-space corresponding to relatively higher level of interference coordination indication is selected for concatenation, including: sub-space 1 (high) for spectral resource block 1; sub-space 3 (middle) for spectral resource block 2; sub-space 2 (high) for spectral resource block 3; sub-space 3 (low) for spectral resource block 4; sub-space 2 (middle) for spectral resource block 5; sub-space 1 (middle) for spectral resource block 6; sub-space 2 (high) for spectral resource block 7; sub-space 1 (middle) for spectral resource block 8; sub-space 4 (middle) for spectral resource block 9; and sub-space 1 (low) for spectral resource block 10. In this way, the resulting interference coordination indication is as follows:

1∥3∥2∥3∥2∥1∥2∥1∥4∥1

where symbol “∥” each denotes a simple concatenation only and the respective expressions do not exist in actual transmission of the interference coordination indication.

### Example 29

### One-Dimensional List (using a Sequence of a Number of Concatenated Index Numbers of Spatial Domain Beams as Signaling)

For each spectral resource block, the index numbers of the spatial domain beams corresponding to a number of interference coordination indications having relatively higher levels are concatenated with each other. Then, a set of such signaling for all of the spectral resource blocks can be used as the interference coordination indication.

The interference coordination indication indicates information on a spatial domain beam the serving BS does not desire a neighboring BS to use. FIG. 8 illustrates the interference coordination indications which take the indication form as shown in FIG. 5. It is assumed that there are 16 beams used for quantization partition of the spatial domain. For each of the spectral resource blocks 1-10, the interference coordination indication signaling associated with each spatial domain beam is a multi-level indication using an enumerative type of signaling. That is, “high” indicates that the serving BS does not desire, to a high extent, the neighboring BS to use the beam at the corresponding location in the next 20 ms; “middle” indicates that the serving BS does not desire, to a moderate extent, the neighboring BS to use the beam at the corresponding location in the next 20 ms; and “low” indicates that the serving BS does not desire, to a low extent, the neighboring BS to use the beam at the corresponding location in the next 20 ms. In this embodiment, for each spectral resource block, the index numbers of four spatial domain beams corresponding to relatively higher levels of interference coordination indications are selected for concatenation, including: beam 1 (high)-beam 6 (middle)-beam 10 (middle)-beam 15 (middle) for spectral resource block 1; beam 5 (high)-beam 11 (high)-beam 12 (middle)-beam 15 (high) for spectral resource block 2; beam 2 (high)-beam 6 (middle)-beam 10 (middle)-beam 14 (middle) for spectral resource block 3; beam 5 (middle)-beam 8 (low)-beam 13 (low)-beam 16 (middle) for spectral resource block 4; beam 2 (middle)-beam 6 (high)-beam 12 (middle)-beam 14 (high) for spectral resource block 5; beam 1 (middle)-beam 5 (middle)-beam 8 (high)-beam 16 (high) for spectral resource block 6; beam 2 (high)-beam 3 (high)-beam 4 (high)-beam 10 (high) for spectral resource block 7; beam 1 (middle)-beam 5 (high)-beam 9 (middle)-beam 13 (middle) for spectral resource block 8; beam 4 (middle)-beam 6 (middle)-beam 8 (middle)-beam 12 (middle) for spectral resource block 9; and beam 5 (high)-beam 10 (middle)-beam 13 (high)-beam 15 (middle) for spectral resource block 10. In this way, the resulting interference coordination indication is as follows:

1-6-11-15∥5-11-12-15∥2-6-10-14∥5-8-13-16∥2-6-12-14∥1-5-8-16∥2-3-4-10∥1-5-9-13∥4-6-8-12∥5-10-13-15

where symbols “-” and “∥” each denotes a simple concatenation only and the respective expressions do not exist in actual transmission of the interference coordination indication.

### Example 30

### One-Dimensional List (using a Sequence of a Number of Concatenated Index Numbers of Spatial Domain Beam Sub-Spaces as Signaling)

For each spectral resource block, the index numbers of the spatial domain beam sub-spaces corresponding to a number of interference coordination indications having relatively higher levels are concatenated with each other. Then, a set of such signaling for all of the spectral resource blocks can be used as the interference coordination indication.

The interference coordination indication indicates information on a spatial domain beam the serving BS does not desire a neighboring BS to use. FIG. 9 illustrates the interference coordination indications which take the indication form as shown in FIG. 5. It is assumed that there are 16 beams used for quantization partition of the spatial domain. For each of the spectral resource blocks 1-10, the interference coordination indication signaling associated with each spatial domain beam sub-space is a multi-level indication using an enumerative type of signaling. That is, “high” indicates that the serving BS does not desire, to a high extent, the neighboring BS to use the sub-space at the corresponding location in the next 20 ms; “middle” indicates that the serving BS does not desire, to a moderate extent, the neighboring BS to use the sub-space at the corresponding location in the next 20 ms; and “low” indicates that the serving BS does not desire, to a low extent, the neighboring BS to use the sub-space at the corresponding location in the next 20 ms. In this embodiment, for each spectral resource block, the index number of one spatial domain beam sub-space corresponding to relatively higher level of interference coordination indication is selected for concatenation, including: sub-space 1 (high) for spectral resource block 1; sub-space 3 (middle) for spectral resource block 2; sub-space 2 (high) for spectral resource block 3; sub-space 3 (low) for spectral resource block 4; sub-space 2 (middle) for spectral resource block 5; sub-space 1 (middle) for spectral resource block 6; sub-space 2 (high) for spectral resource block 7; sub-space 1 (middle) for spectral resource block 8; sub-space 4 (middle) for spectral resource block 9; and sub-space 1 (low) for spectral resource block 10. In this way, the resulting interference coordination indication is as follows:

1∥3∥2∥3∥2∥1∥2∥1∥4∥1

where symbol “∥” each denotes a simple concatenation only and the respective expressions do not exist in actual transmission of the interference coordination indication.

### Example 31

### One-Dimensional List (using a Sequence of a Number of Concatenated Index Numbers of Spatial Domain Beams as Signaling)

For each spectral resource block, the index numbers of the spatial domain beams corresponding to a number of interference coordination indications having relatively higher levels are concatenated with each other. Then, a set of such signaling for all of the spectral resource blocks can be used as the interference coordination indication.

The interference coordination indication indicates information on a spatial domain beam the serving BS desires a neighboring BS to use. FIG. 8 illustrates the interference coordination indications which take the indication form as shown in FIG. 5. It is assumed that there are 16 beams used for quantization partition of the spatial domain. For each of the spectral resource blocks 1-10, the interference coordination indication signaling associated with each spatial domain beam is a multi-level indication using an enumerative type of signaling. That is, “high” indicates that the serving BS desires, to a high extent, the neighboring BS to use the beam at the corresponding location in the next 20 ms; “middle” indicates that the serving BS desires, to a moderate extent, the neighboring BS to use the beam at the corresponding location in the next 20 ms; and “low” indicates that the serving BS desires, to a low extent, the neighboring BS to use the beam at the corresponding location in the next 20 ms. In this embodiment, for each spectral resource block, the index numbers of four spatial domain beams corresponding to relatively higher levels of interference coordination indications are selected for concatenation, including: beam 1 (high)-beam 6 (middle)-beam 10 (middle)-beam 15 (middle) for spectral resource block 1; beam 5 (high)-beam 11 (high)-beam 12 (middle)-beam 15 (high) for spectral resource block 2; beam 2 (high)-beam 6 (middle)-beam 10 (middle)-beam 14 (middle) for spectral resource block 3; beam 5 (middle)-beam 8 (low)-beam 13 (low)-beam 16 (middle) for spectral resource block 4; beam 2 (middle)-beam 6 (high)-beam 12 (middle)-beam 14 (high) for spectral resource block 5; beam 1 (middle)-beam 5 (middle)-beam 8 (high)-beam 16 (high) for spectral resource block 6; beam 2 (high)-beam 3 (high)-beam 4 (high)-beam 10 (high) for spectral resource block 7; beam 1 (middle)-beam 5 (high)-beam 9 (middle)-beam 13 (middle) for spectral resource block 8; beam 4 (middle)-beam 6 (middle)-beam 8 (middle)-beam 12 (middle) for spectral resource block 9; and beam 5 (high)-beam 10 (middle)-beam 13 (high)-beam 15 (middle) for spectral resource block 10. In this way, the resulting interference coordination indication is as follows:

1-6-11-15∥5-11-12-15∥2-6-10-14∥5-8-13-16∥2-6-12-14∥1-5-8-16∥2-3-4-10∥1-5-9-13∥4-6-8-12∥5-10-13-15

where symbols “-” and “∥” each denotes a simple concatenation only and the respective expressions do not exist in actual transmission of the interference coordination indication.

### Example 32

### One-Dimensional List (using a Sequence of a Number of Concatenated Index Numbers of Spatial Domain Beam Sub-Spaces as Signaling)

For each spectral resource block, the index numbers of the spatial domain beam sub-spaces corresponding to a number of interference coordination indications having relatively higher levels are concatenated with each other. Then, a set of such signaling for all of the spectral resource blocks can be used as the interference coordination indication.

The interference coordination indication indicates information on a spatial domain beam the serving BS desires a neighboring BS to use. FIG. 9 illustrates the interference coordination indications which take the indication form as shown in FIG. 5. It is assumed that there are 16 beams used for quantization partition of the spatial domain. For each of the spectral resource blocks 1-10, the interference coordination indication signaling associated with each spatial domain beam sub-space is a multi-level indication using an enumerative type of signaling. That is, “high” indicates that the serving BS desires, to a high extent, the neighboring BS to use the sub-space at the corresponding location in the next 20 ms; “middle” indicates that the serving BS desires, to a moderate extent, the neighboring BS to use the sub-space at the corresponding location in the next 20 ms; and “low” indicates that the serving BS desires, to a low extent, the neighboring BS to use the sub-space at the corresponding location in the next 20 ms. In this embodiment, for each spectral resource block, the index number of one spatial domain beam sub-space corresponding to relatively higher level of interference coordination indication is selected for concatenation, including: sub-space 1 (high) for spectral resource block 1; sub-space 3 (middle) for spectral resource block 2; sub-space 2 (high) for spectral resource block 3; sub-space 3 (low) for spectral resource block 4; sub-space 2 (middle) for spectral resource block 5; sub-space 1 (middle) for spectral resource block 6; sub-space 2 (high) for spectral resource block 7; sub-space 1 (middle) for spectral resource block 8; sub-space 4 (middle) for spectral resource block 9; and sub-space 1 (low) for spectral resource block 10. In this way, the resulting interference coordination indication is as follows:

1∥3∥2∥3∥2∥1∥2∥1∥4∥1

where symbol “∥” each denotes a simple concatenation only and the respective expressions do not exist in actual transmission of the interference coordination indication.

### Example 33

additional information on multi-user MIMO communication load is added to the interference coordination indication in the form of spectral resource block based two-level indication using a bit string type of signaling. FIG. 10 is a schematic diagram of this embodiment. For each of the spectral resource blocks 1-10, the multi-user MIMO communication load can be a two-level indication using a bit string type of signaling. That is, “1” indicates that the serving BS will have a high multi-user MIMO communication load in the next 20 ms, while “0” indicates otherwise. In this way, the signaling for multi-user MIMO communication load is formed by concatenation of the load bit levels corresponding to the spectral resource blocks 1-10.

### Example 34

additional information on multi-user MIMO communication load is added to the interference coordination indication in the form of spectral resource block based multi-level indication using an enumerative type of signaling.

FIG. 11 is a schematic diagram of this embodiment. For each of the spectral resource blocks 1-10, the multi-user MIMO communication load can be a multi-level indication using an enumerative type of signaling. That is, “high” indicates that the serving BS will have a high multi-user MIMO communication load in the next 20 ms; “middle” indicates that the serving BS will have a moderate multi-user MIMO communication load in the next 20 ms; and “low” indicates that the serving BS will have a low multi-user MIMO communication load in the next 20 ms. In this way, the signaling for multi-user MIMO communication load is formed by concatenation of the load bit levels corresponding to the spectral resource blocks 1-10.

It is to be noted that Examples 1-34 as well as the corresponding FIGS. 4-11 are only exemplary examples for illustrating the interference coordination indication according to the present invention. It does not imply that the implementation of the inventive interference coordination indication is limited to the specific forms as described in Examples 1-34 and the corresponding FIGS. 4-11.

At step 515, the serving BS transmits the generated interference coordination indication to a neighboring base station by means of background interface communication.

As an example, the serving BS transmits an interference coordination indication to its neighboring base stations in an omni-directional manner when the interference coordination indication indicates information on a spatial domain beam or a spatial domain beam sub-space likely to be used by the serving base station, or indicates information on a spatial domain beam or a spatial domain beam sub-space unlikely to be used by the serving base station.

As another example, the serving BS transmits an interference coordination indication to a neighboring base station associated with the interference coordination indication in a directional manner when the interference coordination indication indicates information on a spatial domain beam or a spatial domain beam sub-space which the serving base station does not desire the neighboring base station to use, or indicates information on a spatial domain beam or a spatial domain beam sub-space which the serving base station desires the neighboring base station to use.

An interference coordination containing additional information on multi-user MIMO communication load should be transmitted to the neighboring BSs in an omni-directional manner.

It is to be noted that the above approaches for transmitting the interference coordination indication are only examples for explaining the application of the present invention. This step is independent from the other steps of the invention. Thus, modifications to this step have no impact on the implementation of the present invention.

At step 520, the neighboring base station performs resource scheduling based on the received interference coordination indication to reduce or eliminate interference on the serving base station, thereby achieving the purpose of interference coordination.

Preferably, when the interference coordination indication indicates information on a spatial domain beam or a spatial domain beam sub-space likely to be used by the serving BS, the neighboring BS can perform resource scheduling, so as to avoid transmitting data over the resource having high interference.

Preferably, when the interference coordination indication indicates information on a spatial domain beam or a spatial domain beam sub-space unlikely to be used by the serving BS, the neighboring BS can perform resource scheduling, so as to transmit data over the resource having low interference.

Preferably, when the interference coordination indication indicates information on a spatial domain beam or a spatial domain beam sub-space the serving BS does not desire the neighboring BS to use, the neighboring BS can perform resource scheduling, so as to avoid a high interference.

Preferably, when the interference coordination indication indicates information on a spatial domain beam or a spatial domain beam sub-space the serving BS desires the neighboring BS to use, the neighboring BS can perform resource scheduling, so as to generate interference as low as possible.

It is to be noted that the above resource scheduling measures by the neighboring BS are only examples for explaining the application of the present invention. This step is independent from the other steps of the invention. Thus, modifications to this step have no impact on the implementation of the present invention.

Hardware Implementation

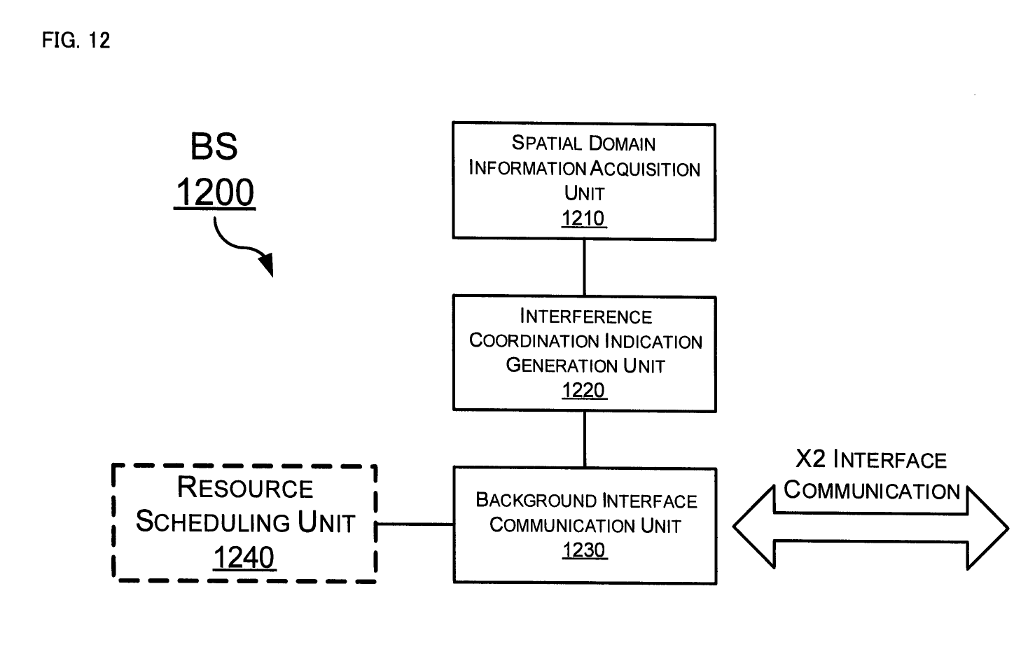

FIG. 12 is an illustrative block diagram of the base station 1200 according to the present invention.

Particularly, as shown in FIG. 12, the BS 1200 of the invention comprises: a spatial domain information acquisition unit 1210 for acquiring spatial domain characteristic information for downlink interference; an interference coordination indication generation unit 1220 for generating an interference coordination indication based on the spatial domain characteristic information for downlink interference acquired by the spatial domain information acquisition unit 1210; and a background interface communication unit 1230 for transmitting, by means of background interface communication (e.g., X2 interface communication), the generated interference coordination indication to a neighboring base station, instructing the neighboring base station to perform resource scheduling, thereby reducing or eliminating interference on the base station.

The above units (i.e., the spatial domain information acquisition unit 1210, the interference coordination indication generation unit 1220 and the background interface communication unit 1230) are components necessary for the BS 1200 as a serving BS. When functioning as a neighboring BS, the BS 1200 can further comprises a resource scheduling unit 1240 (shown in dashed block) for performing resource scheduling based on an interference coordination indication received from the serving BS via the background interface communication unit 1230, so as to reduce or eliminate interference on the serving BS.

Here, according to the above Examples 2, 4, 6, 8, 10, 12, 14, 16, 18, 20, 22, 24, 26, 28, 30 and 32, the interference coordination indication can indicate one of:

[1] information on a spatial domain beam to be used by the BS 1200;

[2] information on a spatial domain beam which is not used or will no longer be used by the BS 1200;

[3] information on a spatial domain beam which the BS 1200 does not desire a neighboring base station to use; and

[4] information on a spatial domain beam which the BS 1200 desires a neighboring base station to use.

In addition, according to the above Examples 1, 3, 5, 7, 9, 11, 13, 15, 17, 19, 21, 23, 25, 27, 29 and 31, the interference coordination indication generation unit 1220 can be configured to group the spatial domain beams into spatial domain beam sub-spaces. Then, according to these Examples 1, 3, 5, 7, 9, 11, 13, 15, 17, 19, 21, 23, 25, 27, 29 and 31, the interference coordination indication can indicate one of:

[1] information on a spatial domain beam sub-space to be used by the BS 1200;

[2] information on a spatial domain beam sub-space which is not used or will no longer be used by the BS 1200;

[3] information on a spatial domain beam sub-space which the BS 1200 does not desire a neighboring base station to use; and

[4] information on a spatial domain beam sub-space which the BS 1200 desires a neighboring base station to use.

Further, the background interface communication unit 1230 transmits an interference coordination indication to the neighboring base stations in an omni-directional manner when the interference coordination indication indicates one of:

information on a spatial domain beam to be used by the BS 1200;

information on a spatial domain beam which is not used or will no longer be used by the BS 1200;

information on a spatial domain beam sub-space to be used by the BS 1200; and

information on a spatial domain beam sub-space which is not used or will no longer be used by the BS 1200.

Further, the background interface communication unit 1230 transmits an interference coordination indication to a neighboring base station associated with the interference coordination indication in a directional manner when the interference coordination indication indicates one of:

information on a spatial domain beam which the BS 1200 does not desire the neighboring base station to use;

information on a spatial domain beam which the BS 1200 desires the neighboring base station to use;

information on a spatial domain beam sub-space which the BS 1200 does not desire the neighboring base station to use; and

information on a spatial domain beam sub-space which the BS 1200 desires the neighboring base station to use.

According to the above Examples 1, 2, 5, 6, 9, 10, 13 and 14, the interference coordination indication can be a two-level indication using a bit string type of signaling. Alternatively, according to the above Examples 3, 4, 7, 8, 11, 12 and 15-32, the interference coordination indication can be a multi-level indication using an enumerative type of signaling. Additionally, according to the above Examples 1-16, the interference coordination indication can be a two-dimensional table with a first dimension representing spectral resource blocks and a second dimension representing spatial domain beams or spatial domain beam sub-spaces. Alternatively, according to the above Examples 17-32, the interference coordination indication can be a one-dimensional list, each element of which contains an index number for a spectral resource block concatenated with an index number for a spatial domain beam, or an index number for a spectral resource block concatenated with an index number for a spatial domain beam sub-space.

In addition, the interference coordination indication can contain additional information indicating multi-user MIMO communication load. According to the above Example 33, the additional information indicating multi-user MIMO communication load can be a spectral resource block based two-level indication using a bit string type of signaling. Alternatively, according to the above Example 34, the additional information indicating multi-user MIMO communication load can be a spectral resource block based multi-level indication using an enumerative type of signaling.

Here, the background interface communication unit 1230 can transmit the interference coordination indication containing the additional information indicating multi-user MIMO communication load to the neighboring base stations in an omni-directional manner.

The present invention has been described above with reference to the preferred embodiments thereof. It should be understood that various modifications, alternations and additions can be made by those who skilled in the art without departing from the spirits and scope of the present invention. Therefore, the scope of the present invention is not limited to the above particular embodiments but only defined by the claims as attached.

1-27. (canceled)

28. A base station, comprising:
a spatial domain information acquisition unit for acquiring spatial domain characteristic information for downlink interference;
an interference coordination indication generation unit for generating an interference coordination indication based on the spatial domain characteristic information for downlink interference acquired by the spatial domain information acquisition unit; and
a background interface communication unit for transmitting, by means of background interface communication, the generated interference coordination indication to a neighboring base station, instructing the neighboring base station to perform resource scheduling, thereby reducing or eliminating interference on the base station.

29. The base station according to claim 28, further comprising:
a resource scheduling unit for performing resource scheduling based on an interference coordination indication received from a neighboring base station via the background interface communication unit, so as to reduce or eliminate interference on the neighboring base station.

30. The base station according to claim 28, wherein
the interference coordination indication is used to indicate at least one of:
information on a spatial domain beam to be used by the base station;
information on a spatial domain beam which is not used or will no longer be used by the base station;
information on a spatial domain beam which the base station does not desire a neighboring base station to use; and
information on a spatial domain beam which the base station desires a neighboring base station to use.

31. The base station according to claim 28, wherein
the interference coordination indication generation unit is configured to group a number of spatial domain beams into a spatial domain beam sub-space; and
the interference coordination indication is used to indicate at least one of:
information on a spatial domain beam sub-space to be used by the base station;
information on a spatial domain beam sub-space which is not used or will no longer be used by the base station;
information on a spatial domain beam sub-space which the base station does not desire a neighboring base station to use; and
information on a spatial domain beam sub-space which the base station desires a neighboring base station to use.

32. The base station according to claim 30, wherein
the background interface communication unit is configured to transmit an interference coordination indication to the neighboring base stations in an omni-directional manner when the interference coordination indication indicates one of:
information on a spatial domain beam to be used by the base station;
information on a spatial domain beam which is not used or will no longer be used by the base station;
information on a spatial domain beam sub-space to be used by the base station; and
information on a spatial domain beam sub-space which is not used or will no longer be used by the base station.

33. The base station according to claim 31, wherein
the background interface communication unit is configured to transmit an interference coordination indication to the neighboring base stations in an omni-directional manner when the interference coordination indication indicates one of:
information on a spatial domain beam to be used by the base station;
information on a spatial domain beam which is not used or will no longer be used by the base station;
information on a spatial domain beam sub-space to be used by the base station; and
information on a spatial domain beam sub-space which is not used or will no longer be used by the base station.

34. The base station according to claim 30, wherein
the background interface communication unit is configured to transmit an interference coordination indication to a neighboring base station associated with the interference coordination indication in a directional manner when the interference coordination indication indicates one of:
information on a spatial domain beam which the base station does not desire the neighboring base station to use;
information on a spatial domain beam which the base station desires the neighboring base station to use;
information on a spatial domain beam sub-space which the base station does not desire the neighboring base station to use; and
information on a spatial domain beam sub-space which the base station desires the neighboring base station to use.

35. The base station according to claim 31, wherein
the background interface communication unit is configured to transmit an interference coordination indication to a neighboring base station associated with the interference coordination indication in a directional manner when the interference coordination indication indicates one of:
information on a spatial domain beam which the base station does not desire the neighboring base station to use;
information on a spatial domain beam which the base station desires the neighboring base station to use;
information on a spatial domain beam sub-space which the base station does not desire the neighboring base station to use; and
information on a spatial domain beam sub-space which the base station desires the neighboring base station to use.

36. The base station according to claim 28, wherein
the interference coordination indication is a two-level indication using a bit string type of signaling.

37. The base station according to claim 28, wherein
the interference coordination indication is a multi-level indication using an enumerative type of signaling.

38. The base station according to claim 28, wherein
the interference coordination indication is a two-dimensional table with a first dimension representing spectral resource blocks and a second dimension representing spatial domain beams or spatial domain beam sub-spaces.

39. The base station according to claim 28, wherein
the interference coordination indication is a one-dimensional list, each element of which contains an index number for a spectral resource block concatenated with an index number for a spatial domain beam, or an index number for a spectral resource block concatenated with an index number for a spatial domain beam sub-space.

40. The base station according to claim 28, wherein
the interference coordination indication is a one-dimensional list, each element of which contains a number of concatenated index numbers for spatial domain beams, or a index number for spatial domain beam sub-space.

41. The base station according to claim 28, wherein
the interference coordination indication contains additional information indicating multi-user MIMO communication load.

42. The base station according to claim 41, wherein
the additional information indicating multi-user MIMO communication load is a spectral resource block based two-level indication using a bit string type of signaling; or
the additional information indicating multi-user MIMO communication load can be a spectral resource block based multi-level indication using an enumerative type of signaling.

43. The base station according to claim 41, wherein
the background interface communication unit is configured to transmit the interference coordination indication to the neighboring base stations in an omni-directional manner.

44. A method for interference coordination, comprising:
acquiring, by a serving base station, spatial domain characteristic information for downlink interference;
generating, by the serving base station, an interference coordination indication based on the acquired spatial domain characteristic information for downlink interference;
transmitting, by the serving base station, the generated interference coordination indication to a neighboring base station by means of background interface communication; and
performing, by the neighboring base station, resource scheduling based on the received interference coordination indication, so as to reduce or eliminate interference on the serving base station.

45. The method for interference coordination according to claim 44, wherein
the interference coordination indication is used to indicate at least one of:
information on a spatial domain beam to be used by the serving base station;
information on a spatial domain beam which is not used or will no longer be used by the serving base station;
information on a spatial domain beam which the serving base station does not desire a neighboring base station to use; and
information on a spatial domain beam which the serving base station desires a neighboring base station to use.

46. The method for interference coordination according to claim 44, wherein
a number of spatial domain beams are grouped into a spatial domain beam sub-space; and
the interference coordination indication is used to indicate at least one of:
information on a spatial domain beam sub-space to be used by the serving base station;
information on a spatial domain beam sub-space which is not used or will no longer be used by the serving base station;
information on a spatial domain beam sub-space which the serving base station does not desire a neighboring base station to use; and
information on a spatial domain beam sub-space which the serving base station desires a neighboring base station to use.

47. The method for interference coordination according to claim 45, wherein
the serving base station transmits an interference coordination indication to its neighboring base stations in an omni-directional manner when the interference coordination indication indicates one of:
information on a spatial domain beam to be used by the serving base station;
information on a spatial domain beam which is not used or will no longer be used by the serving base station;
information on a spatial domain beam sub-space to be used by the serving base station; and
information on a spatial domain beam sub-space which is not used or will no longer be used by the serving base station.

48. The method for interference coordination according to claim 46, wherein
the serving base station transmits an interference coordination indication to its neighboring base stations in an omni-directional manner when the interference coordination indication indicates one of:
information on a spatial domain beam to be used by the serving base station;
information on a spatial domain beam which is not used or will no longer be used by the serving base station;
information on a spatial domain beam sub-space to be used by the serving base station; and
information on a spatial domain beam sub-space which is not used or will no longer be used by the serving base station.

49. The method for interference coordination according to claim 45, wherein
the serving base station transmits an interference coordination indication to a neighboring base station associated with the interference coordination indication in a directional manner when the interference coordination indication indicates one of:
information on a spatial domain beam which the serving base station does not desire the neighboring base station to use;
information on a spatial domain beam which the serving base station desires the neighboring base station to use;
information on a spatial domain beam sub-space which the serving base station does not desire the neighboring base station to use; and
information on a spatial domain beam sub-space which the serving base station desires the neighboring base station to use.

50. The method for interference coordination according to claim 46, wherein
the serving base station transmits an interference coordination indication to a neighboring base station associated with the interference coordination indication in a directional manner when the interference coordination indication indicates one of:
information on a spatial domain beam which the serving base station does not desire the neighboring base station to use;
information on a spatial domain beam which the serving base station desires the neighboring base station to use;
information on a spatial domain beam sub-space which the serving base station does not desire the neighboring base station to use; and
information on a spatial domain beam sub-space which the serving base station desires the neighboring base station to use.

51. The method for interference coordination according to claim 44, wherein
the interference coordination indication is a two-level indication using a bit string type of signaling.

52. The method for interference coordination according to claim 44, wherein
the interference coordination indication is a multi-level indication using an enumerative type of signaling.

53. The method for interference coordination according to claim 44, wherein
the interference coordination indication is a two-dimensional table with a first dimension representing spectral resource blocks and a second dimension representing spatial domain beams or spatial domain beam sub-spaces.

54. The method for interference coordination according to claim 44, wherein
the interference coordination indication is a one-dimensional list, each element of which contains an index number for a spectral resource block concatenated with an index number for a spatial domain beam, or an index number for a spectral resource block concatenated with an index number for a spatial domain beam sub-space.

55. The method for interference coordination according to claim 44, wherein
the interference coordination indication is a one-dimensional list, each element of which contains a number of concatenated index numbers for spatial domain beams, or a index number for spatial domain beam sub-space.

56. The method for interference coordination according to claim 44, wherein
the interference coordination indication contains additional information indicating multi-user MIMO communication load.

57. The method for interference coordination according to claim 56, wherein
the additional information indicating multi-user MIMO communication load is a spectral resource block based two-level indication using a bit string type of signaling; or
the additional information indicating multi-user MIMO communication load can be a spectral resource block based multi-level indication using an enumerative type of signaling.

58. The method for interference coordination according to claim 56, wherein
the serving base station transmits the interference coordination indication to its neighboring base stations in an omni-directional manner.
